(19) United States
(12) Patent Application Publication
(10) Pub. No.: US 2025/0314984 A1
(43) Pub. Date: Oct. 9, 2025

(54) TONER AND METHOD OF PRODUCING TONER

(71) Applicant: CANON KABUSHIKI KAISHA, Tokyo (JP)

(72) Inventors: TAKESHI HASHIMOTO, Ibaraki (JP); MEGUMI SHINO, Chiba (JP); GAKU SATO, Chiba (JP); JUNICHI TAMURA, Ibaraki (JP); HAYATO IDA, Ibaraki (JP)

(21) Appl. No.: 19/241,711

(22) Filed: Jun. 18, 2025

Related U.S. Application Data
(63) Continuation of application No. PCT/JP2023/045961, filed on Dec. 21, 2023.

(30) Foreign Application Priority Data
Dec. 26, 2022 (JP) 2022-207914
Dec. 8, 2023 (JP) 2023-207601
Dec. 13, 2023 (JP) 2023-210365

(51) Int. Cl. G03G 9/087; G03G 9/08

(52) U.S. Cl. CPC G03G 9/08795; G03G 9/081; G03G 9/0815; G03G 9/08728; G03G 9/08782

(57) ABSTRACT

A toner containing a toner particle containing a binder resin and a wax, wherein the binder resin contains a crystalline resin, the content of the crystalline resin is within a specific range, in viscoelastic measurement of the toner, when a storage elastic modulus of the toner at a temperature T (° C.) is G′(T), in a graph in which a horizontal axis represents the temperature T, and a vertical axis represents a value d(log G′(T))/dT obtained by differentiating Log G′(T) with respect to the temperature T, the local minimum value is observed in a specific range, when a temperature at which the local minimum value is reached is defined as a temperature T1 (° C.), d(log G′(T1))/dT, d(log G′(T1+3))/dT≤0, G′(T1), and G′(T1+30) satisfy specific relationships.

### CROSS-REFERENCE TO RELATED APPLICATIONS

This application is a Continuation of International Patent Application No. PCT/JP2023/045961, filed Dec. 21, 2023, which claims the benefit of Japanese Patent Application No. 2022-207914, filed Dec. 26, 2022, Japanese Patent Application No. 2023-207601, filed Dec. 8, 2023, and Japanese Patent Application No. 2023-210365, filed Dec. 13, 2023, all of which are hereby incorporated by reference herein in their entirety.

### BACKGROUND

### Field of the Technology

The present disclosure relates to a toner used in an electrophotographic system, an electrostatic recording system, an electrostatic printing system, and a toner jet system and a method of producing a toner.

### Description of the Related Art

In recent years, electrophotographic devices such as full-color printers and full-color copying machines have been increasingly required to provide additional value such as high productivity, high image quality, and high stability.

In order to achieve high productivity, it is important to melt a toner more quickly during a fixing step. Specifically, when the main component of a binder resin of the toner is a crystalline resin having sharp melting properties, it is possible to achieve excellent low-temperature fixability as compared to a toner whose main component is an amorphous resin.

For example, Japanese Patent Laid-Open No. 2014-130243 proposes a toner that achieves both low-temperature fixability and heat-resistant storability by using an acrylate-based resin having crystallinity in the side chain. However, it has been found that a toner using a crystalline resin having low-temperature fixability exhibits low strength at normal temperature and the fixed image is vulnerable to rubbing and scratching.

Thus, Japanese Patent Laid-Open No. 2014-142632 proposes a toner that enables low-temperature fixing by using a binder resin in which a crystalline vinyl resin matrix and an amorphous resin domain are used in combination, and produces images that are resistant to external forces such as rubbing and scratching due to its domain structure.

On the other hand, the performance required for electrophotographic devices has been increasing year by year, and it is required to stably obtain printed outputs with high image quality even when outputting at a high speed and in a large amount over a long period of time under various environments. In addition, the robustness of the printed outputs has also become important, and they are required to have resistance to abrasion and scratches and heat resistance. In addition, there is also a demand for achieving image glossiness and reducing image density non-uniformity on fixing media with significant unevenness such as rough paper.

According to studies performed by the inventors, the toner described in Japanese Patent Laid-Open No. 2014-142632 is insufficient to meet the currently required level of image robustness, and there is a strong demand for improvement, particularly in the scratch resistance of images printed on smooth media such as coated paper.

### SUMMARY

At least one aspect of the present disclosure provides a toner that exhibits excellent low-temperature fixability and excellent resistance to scratches on an image printed on smooth media such as coated paper, and can achieve image glossiness and reduce image density non-uniformity on fixing media with significant unevenness. In addition, at least one aspect of the present disclosure provides a method of producing the toner.

At least one aspect of the present disclosure relates to a toner comprising a toner particle comprising a binder resin and a wax, wherein the binder resin comprises a crystalline resin, the content of the crystalline resin based on the mass of the toner particle is 30.0 to 95.0 mass %, in viscoelastic measurement of the toner, when a storage elastic modulus of the toner at a temperature T (° C.) is G′(T), in a graph in which a horizontal axis represents the temperature T, and a vertical axis represents a value d(log G′(T))/dT obtained by differentiating Log G′(T) with respect to the temperature T, the local minimum value is observed in a range of 50.0 to 70.0° C., and when a temperature at which the local minimum value is reached is defined as a temperature T1 (° C.), d(log G′(T1))/dT is −2.00 to −0.20, d(log G′(T1+3))/dT≤0, d(log G′(T1+3))/dT−d(log G′(T1))/dT is 0.15 to 1.90, G′(T1) is 5.0×10⁵ to 2.0×10⁷ Pa, and G′(T1+30) is 1.0×10² to 5.0×10⁴ Pa.

At least one aspect of the present disclosure relates to a method of producing the above-mentioned toner, the method comprising: a melt-kneading step in which a mixture comprising the crystalline resin and the wax is melt-kneaded; and an annealing step in which the melt-kneaded product obtained in the melt-kneading step is held at a temperature at least 5° C. higher than the melting point of the crystalline resin.

Features of the present disclosure will become apparent from the following description of embodiments.

### DESCRIPTION OF THE EMBODIMENTS

In the present disclosure, “from XX to YY” or “XX to YY” indicating a numerical range means a numerical range including a lower limit and an upper limit that are end points unless otherwise specified.

The term (meth)acrylic acid ester refers to an acrylic acid ester and/or methacrylic acid ester.

When the numerical ranges are expressed in stages, the upper limits and lower limits of the numerical ranges can be arbitrarily combined.

The term “monomer unit” refers to a reacted form of a monomer substance in a polymer. For example, one unit is one carbon-carbon bond segment in the main chain of a polymer formed by polymerizing vinyl-based monomers. The vinyl-based monomer can be represented by the following formula (Z).

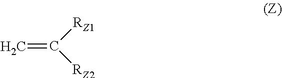

In the formula (Z), R_{Z1} represents a hydrogen atom or an alkyl group (preferably an alkyl group having 1 to 3 carbon atoms, and more preferably a methyl group), and R_{Z2} represents an optional substituent.

The crystalline resin is a resin that exhibits a clear endothermic peak in differential scanning calorimeter (DSC) measurement.

Hereinafter, a toner of the present disclosure will be described in detail.

The present disclosure relates to a toner comprising a toner particle comprising a binder resin and a wax, wherein the binder resin comprises a crystalline resin, the content of the crystalline resin based on the mass of the toner particle is 30.0 to 95.0 mass %, in viscoelastic measurement of the toner, when a storage elastic modulus of the toner at a temperature T (° C.) is G′(T), in a graph in which a horizontal axis represents the temperature T, and a vertical axis represents a value d(log G′(T))/dT obtained by differentiating Log G′(T) with respect to the temperature T, the local minimum value is observed in a range of 50.0 to 70.0° C., and when a temperature at which the local minimum value is reached is defined as a temperature T1 (° C.), d(log G′(T1))/dT is −2.00 to −0.20, d(log G′(T1+3))/dT≤0, d(log G′(T1+3))/dT−d(log G′(T1))/dT is 0.15 to 1.90, G′(T1) is 5.0×10⁵ to 2.0×10⁷ Pa, and G′(T1+30) is 1.0×10² to 5.0×10⁴ Pa.

The inventors conducted extensive studies, and as a result, found that, in a toner containing a crystalline resin, when the viscoelasticity of the toner is controlled to be within a specific range, the toner exhibits excellent low-temperature fixability and scratch resistance for images printed on smooth media.

The inventors speculate the reason why the above problem has been solved is as follows.

The crystalline resin used in the toner has a smaller internal cohesive force than the amorphous resin, and is easily destroyed when subjected to external forces such as scratching or rubbing, resulting in low image robustness. In Japanese Patent Laid-Open No. 2014-142632, a sea-island structure is formed using a crystalline resin and an amorphous resin in combination, and the image intensity can be increased to a certain extent. However, since the sea part, which is a continuous layer, is formed of the crystalline resin with a low internal cohesive force, significant improvements in the robustness of the image have not been possible.

On the other hand, the toner of the present disclosure has the following features.

In viscoelastic measurement of the toner, when a storage elastic modulus of the toner at T (° C.) is defined as G′(T), a graph in which a horizontal axis represents the temperature T, and a vertical axis represents a value d(log G′(T))/dT obtained by differentiating Log G′(T) with respect to the temperature T is obtained:
(i) In the graph, the local minimum value is observed in a range of 50.0 to 70.0° C. Here, a temperature at which the local minimum value is reached is defined as a temperature T1 (° C.).

$$d ( log {G}^{′} ( T 1 ) ) / dT is - 2. to - 0.2 . \qquad ( ii )$$

$$d ( log {G}^{′} ( T 1 + 3 ) ) / dT \leq 0. \qquad ( iii )$$

$$d ( {logG}^{′} ( T 1 + 3 ) ) / dT - d ( log {G}^{′} ( T 1 ) ) / dT is 0.15 to 1.9 . \qquad ( iv )$$

$${G}^{′} ( T 1 ) is 5. \times 1 {0}^{5} Pa to 2. \times 1 {0}^{7} Pa . \qquad ( v )$$

$${G}^{′} ( T 1 + 30 ) is 1. \times 1 {0}^{2} Pa to 5. \times 1 {0}^{4} Pa . \qquad ( vi )$$

In a graph in which a horizontal axis represents temperature T and a vertical axis represents d(log G′(T))/dT, a local minimum value is observed at a temperature T1 (° C.) in a range of 50 to 70° C., and when d(log G′(T1))/dT is −2.00 to −0.20, this indicates that the storage elastic modulus decreases suddenly in a range of 50 to 70° C. Here, log G′(T1) indicates Log G′(T) at the temperature T1. log G′(T1+3) indicates Log G′(T) at the temperature T1+3° C.

In addition, when d(log G′(T1+3))/dT≤0, and d(log G′(T1+3))/dT−d(log G′(T1))/dT is 0.15 to 1.90, this indicates that the degree of decrease in storage elastic modulus at T1+3° C. is significantly smaller than the degree of sudden decrease in the storage elastic modulus at T1° C.

A feature that the degree of decrease in viscoelasticity of the toner differs greatly despite a small temperature difference such as 3° C. is not exhibited by conventional toners. In addition, according to studies performed by the inventors, such a feature is not exhibited unless a wax is present, and thus it is speculated that the toner according to the present disclosure has a structure different from that of conventional toners.

Specifically, the inventors speculate that the toner of the present disclosure has a structure in which a discontinuous phase of a crystalline resin alone is dispersed in a continuous phase of a eutectic of a crystalline resin and a wax. If such a structure is used, the crystalline resin in the discontinuous phase melts when the melting point of the crystalline resin is exceeded, and thus the storage elastic modulus decreases suddenly. However, once the discontinuous phase of the crystalline resin has completely melted, the viscoelasticity of the entire toner is dominated by the viscoelasticity of the eutectic of the crystalline resin in the continuous phase and the wax, which can explain why the decrease in viscoelasticity suddenly becomes small.

Assuming that images formed with the toner also have a similar structure, it is thought that, in addition to the continuous phase with an increased internal cohesive force due to the eutectic of the crystalline resin and the wax, the crystalline resin phase existing as the discontinuous phase exhibits a filler effect, and thus the image intensity can dramatically increase.

In the toner of the present disclosure, in a graph in which a horizontal axis represents the temperature T and a vertical axis represents d(log G′(T))/dT, a local minimum value is observed in a range of 50.0 to 70.0° C. The temperature at which the local minimum value is reached is defined as a temperature T1 (° C.). When the local minimum value is higher than 70.0° C., the low-temperature fixability is likely to decrease.

In order to achieve both the low-temperature fixability and storability, it is preferably in a range of 55.0 to 65.0° C., and more preferably in a range of 57.0 to 65.0° C. The temperature T1 can be controlled, for example, by changing the melting point of the crystalline resin. In addition, the temperature T1 can also be controlled by changing the glass transition point of the amorphous resin.

In addition, in the toner, in a graph in which a horizontal axis represents the temperature T and a vertical axis represents d(log G′(T))/dT, d(log G′(T1))/dT is −2.00 to −0.20. d(log G′(T1))/dT is preferably −2.00 to −0.30, more preferably −2.00 to −0.40, and still more preferably −1.70 to −0.40.

When d(log G′(T1))/dT is a value larger than −0.20, since the degree of decrease in storage elastic modulus is small, the sharp melting properties of the toner deteriorate and the low-temperature fixability decreases. Making d(log G′(T1))/dT smaller than −2.00 is a way to further improve the sharp melting properties, but it is currently difficult to perform production in the presence of other raw materials such as a colorant and an external additive contained in the toner.

In the toner of the present disclosure, in a graph in which a horizontal axis represents the temperature T and a vertical axis represents d(log G′(T))/dT, d(log G′(T1+3))/dT≤0, and d(log G′(T1+3))/dT−d(log G′(T1))/dT is 0.15 to 1.90.

When d(log G′(T1+3))/dT>0, since the storage elastic modulus increases as the temperature increases, the low-temperature fixability decreases. d(log G′(T1+3))/dT is preferably −0.50 to −0.03.

d(log G′(T1+3))/dT−d(log G′(T1))/dT indicates the difference in the degree of decrease in storage elastic modulus at the temperature T1 at which a local minimum value is reached and T1+3° C. d(log G′(T1+3))/dT−d(log G′(T1))/dT is preferably 0.20 to 1.90, more preferably 0.25 to 1.90, still more preferably 0.30 to 1.90, and yet more preferably 0.30 to 1.60.

When d(log G′(T1+3))/dT−d(log G′(T1))/dT is less than 0.15, this indicates that the difference in the degree of decrease of the storage elastic modulus is small, suggesting that the crystalline resin is also present in a continuous phase, and the scratch resistance of the formed image decreases.

Regarding the means for controlling d(log G′(T1))/dT, d(log G′(T1))/dT can be increased by increasing the content of the crystalline resin. When a crystalline vinyl resin is used as the crystalline resin, d(log G′(T1))/dT can be increased by increasing the content of the first monomer unit. In addition, d(log G′(T1))/dT can be decreased by decreasing the content of the crystalline resin. When a crystalline vinyl resin is used as the crystalline resin, d(log G′(T1))/dT can be decreased by decreasing the content of the first monomer unit. In addition, when an amorphous resin is used in combination as the binder resin, d(log G′(T1))/dT can also be controlled by changing the difference |Tc−Tg| between the melting point of the crystalline resin and the glass transition point of the amorphous resin.

In addition, in the toner production using a melt-kneading method, it is also effective to subject the melt-kneaded product obtained after the melt-kneading step to an annealing treatment in which the product is held at a temperature at least 5° C. higher than the melting point Tc of the crystalline resin for 30 minutes or longer in order to control (log G′(T1))/dT to be within the above range.

The means for making d(log G′(T1+3))/dT≤0 is not particularly limited because the storage elastic modulus of a general toner decreases as the temperature increases.

As a method of controlling the value of d(log G′(T1+3))/dT−d(log G′(T1))/dT to be within the above range, in the toner production by the melt-kneading method described above, it is effective to subject the melt-kneaded product obtained after the melt-kneading step to an annealing step in which the product is held at a temperature at least 5° C. higher than the melting point Tc of the crystalline resin for 30 minutes or longer. According to this step, eutectic formation of the crystalline resin and the wax proceeds to form a continuous layer, and the crystalline resin that has not formed a eutectic can independently form a discontinuous phase.

The toner has a G′(T1) of 5.0×10⁵ to 2.0×10⁷ Pa. G′(T1) is the value of G′(T) when the temperature T is T1. When G′(T1) is less than 5.0×10⁵ Pa, the scratch resistance of the fixed image decreases. On the other hand, when G′(T1) exceeds 2.0×10⁷ Pa, the low-temperature fixability decreases. G′(T1) is preferably 5.0×10⁵ to 2.0×10⁷ Pa, and more preferably 1.0×10⁶ to 1.0×10⁷ Pa.

The storage elastic modulus G′(T1) can be controlled, for example, by the following method.

For example, the storage elastic modulus can also be controlled by the amorphous monomer unit of the crystalline resin in addition to the amount of the crystalline resin added and the amount of the crystalline component in the crystalline resin. In addition, it can also be controlled by incorporating the amorphous resin into the toner particle or changing the type and content of the amorphous resin. In addition, it can also be controlled by incorporating a filler material into the toner particle. Specifically, G′(T1) can be easily increased by decreasing the amount of the crystalline resin added, decreasing the amount of the crystalline component in the crystalline resin, or increasing the filler content in the toner particle. In addition, G′(T1) can be easily decreased by increasing the amount of the crystalline resin added, increasing the amount of the crystalline component in the crystalline resin, or decreasing the filler content in the toner particle.

In addition, the toner has a G′(T1+30) of 1.0×10² to 5.0×10⁴ Pa. G′(T1+30) is the storage elastic modulus at a temperature about 30° C. higher than the melting temperature of the crystalline resin, and corresponds to the storage elastic modulus of the toner in the fixing nip. That is, G′(T1+30) is the value of G′(T) when the temperature T is T1+30° C.

When G′(T1+30) is less than 1.0×10² Pa, since the viscosity at the fixing nip part is too low, in fixing media with significant unevenness such as rough paper, the toner on the protruded portion melts and tends to flow into the depressed portion, and image density non-uniformity reflecting the unevenness of the fixing media, known as mottle, tends to occur. On the other hand, when G′(T1+30) exceeds 5.0×10⁴ Pa, the toner is unlikely to melt and the image glossiness decreases.

G′(T1+30) is preferably 5.0×10² Pa to 3.0×10⁴ Pa, and more preferably 1.0×10³ Pa to 3.0×10⁴ Pa.

The storage elastic modulus at G′(T1+30) can be controlled by the type and amount of the wax and binder resin added. In addition, when the melting point of the wax is changed, the melting point of the eutectic of the crystalline resin and the wax can be changed and the storage elastic modulus at G′(T1+30) can be changed. In addition, it is also effective to subject the melt-kneaded product obtained after the melt-kneading step to an annealing step. Specifically, G′(T1+30) can be easily increased by increasing the melting point of the wax. In addition, G′(T1+30) can be easily decreased by decreasing the melting point of the wax.

In addition, in measurement of the endothermic amount of the toner using a differential scanning calorimeter, the total endothermic amount J/g (derived from the wax) per 1 g of the wax is defined as ΔH(T). In addition, in the measurement of the endothermic amount of the wax, the total endothermic amount J/g per 1 g of the wax is ΔH(W).

In this case, 0.70≤ΔH(T)/ΔH(W)≤0.90 is preferable and 0.71≤ΔH(T)/ΔH(W)≤0.87 is more preferable.

Regarding the crystallinity of the wax, ΔH(T)/ΔH(W) indicates the rate of change in crystallinity when raw materials are formed into a toner, and is an index of compatibility of the wax with respect to the binder resin. When ΔH(T)/ΔH(W) is 0.70 or more, the amount of the wax that is compatible with the binder resin is appropriate, and a eutectic with the crystalline resin is more easily formed. On the other hand, when ΔH(T)/ΔH(W) is 0.90 or less, the wax does not undergo complete phase separation from the binder resin, and the interaction is more likely to occur.

ΔH(T)/ΔH(W) can be increased by, for example, increasing the difference between SP values of the crystalline resin and the wax, or increasing the melting point of the wax. ΔH(T)/ΔH(W) can be decreased, for example, by making the SP values of the crystalline resin and the wax closer to each other, or decreasing the melting point of the wax.

In addition, when an amorphous resin is additionally used as the binder resin, it is possible to control the value of ΔH(T)/ΔH(W) by similarly controlling the SP values of the amorphous resin and the wax.

In addition, ΔH(T)/ΔH(W) can be controlled depending on kneading conditions and annealing conditions. Particularly, ΔH(T)/ΔH(W) can be increased by performing annealing.

The SP value ((J/cm³)^{0.5}) of the crystalline resin is preferably 18.0 to 21.0, more preferably 19.0 to 21.0, and still more preferably 19.5 to 21.0. The SP value of the wax is preferably 16.0 to 19.0, and more preferably 16.5 to 17.5.

The inventors speculate that the wax and the crystalline resin form a eutectic. Therefore, in the present disclosure, for the endothermic amount “derived from the wax” of the toner, a peak having a peak that is within ±5° C. of the peak temperature of the endothermic peak observed in the measurement of the endothermic amount of the wax alone is determined as a peak derived from the wax of the toner.

Subsequently, raw materials will be described.

### <Crystalline Resin>

The toner particle contains a binder resin, and the binder resin contains a crystalline resin. As the crystalline resin, known crystalline resins that can be used in the toner can be used. Specific examples thereof include a crystalline polyester resin and a crystalline vinyl resin. In consideration of charge stability in a high temperature and high humidity environment, a crystalline vinyl resin is preferable.

The crystalline resin preferably has a first monomer unit represented by the following formula (1) (hereinafter simply referred to as a first monomer unit).

In addition, the content of the first monomer unit in the crystalline resin based on the mass of all monomer units in the crystalline resin is preferably 30.0 mass % or more. Within the above range, the crystalline resin has sufficient crystallinity, and the low-temperature fixability is further improved.

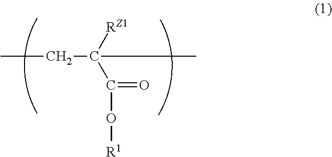

In the formula (1), R_{Z1} represents a hydrogen atom or a methyl group, and R¹ represents an alkyl group having 18 to 36 carbon atoms. R¹ is preferably an alkyl group having 18 to 30 carbon atoms, and more preferably an alkyl group having 20 to 24 carbon atoms. In addition, the alkyl group preferably has a linear structure.

The first monomer unit has an alkyl group having 18 to 36 carbon atoms represented by R¹ in the side chain, and when this alkyl group is crystallized, the crystalline resin easily exhibits crystallinity.

When the content of the first monomer unit in the crystalline resin is 30.0 mass % or more, the crystallinity is more easily exhibited, and the low-temperature fixability is further improved. The content of the first monomer unit in the crystalline resin is preferably 30.0 to 100.0 mass %, more preferably 40.0 to 100.0 mass %, and still more preferably 50.0 to 100.0 mass %.

The crystalline vinyl resin has better charge retention properties under a high temperature and high humidity environment than a crystalline polyester, which is a well-known conventional crystalline resin, because it has a structure with crystallinity in the side chain. In addition, it is thought that the crystalline vinyl resin has a structure with crystallinity in the side chain, which improves the interaction with the wax to be described below and makes it easier to form a eutectic with the wax.

The first monomer unit is preferably a monomer unit formed of at least one (first polymerizable monomer) selected from the group consisting of (meth)acrylic acid esters having an alkyl group having 18 to 36 carbon atoms.

Examples of (meth)acrylic acid esters having an alkyl group having 18 to 36 carbon atoms include (meth)acrylic acid esters having a linear alkyl group having 18 to 36 carbon atoms [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, and the like] and (meth)acrylic acid esters having a branched alkyl group having 18 to 36 carbon atoms [2-decyltetradecyl (meth)acrylate, and the like].

Among these, in consideration of the low-temperature fixability of the toner, at least one selected from the group consisting of (meth)acrylic acid esters having a linear alkyl group having 18 to 36 carbon atoms is preferable, at least one selected from the group consisting of (meth)acrylic acid esters having a linear alkyl group having 18 to 30 carbon atoms is more preferable, and at least one selected from the group consisting of linear stearyl (meth)acrylates and behenyl (meth)acrylates is still more preferable.

The monomers forming the first monomer unit may be used alone or two or more thereof may be used in combination.

The crystalline vinyl resin may contain monomer units other than the first monomer unit.

Examples of polymerizable monomers forming monomer units other than the first monomer unit include the following monomers. In addition, the polymerizable monomers forming other monomer units may be used alone or two or more thereof may be used in combination.

The monomer units other than the first monomer unit are roughly classified into a second monomer unit represented by the following formula (2) (hereinafter simply referred to as a second monomer unit), a third monomer unit represented by the following formula (3) (hereinafter simply referred to as a third monomer unit), and a monomer unit other than the first, second and third monomer units.

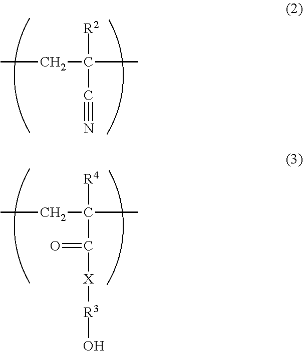

In the formula (2), R² represents a hydrogen atom or a methyl group.

In the formula (3), X represents —O— or —NH— (preferably —O—), R⁴ represents a hydrogen atom or a methyl group, and R³ represents an alkylene group having 2 to 6 (preferably 2 to 4 and more preferably 2 or 3) carbon atoms.

The second monomer unit has a polar group that is directly bonded to the main chain of the crystalline vinyl resin. Examples of polymerizable monomers that form the second monomer unit include acrylonitrile and methacrylonitrile.

The third monomer unit has a polar hydroxy group at a position away from the main chain. Examples of polymerizable monomers that form the third monomer unit include the following polymerizable monomers.

2-hydroxyethyl (meth)acrylate, 2-hydroxypropyl (meth)acrylate, 2-hydroxyethylamide (meth)acrylate, 2-hydroxypropylamide (meth)acrylate.

Examples of polymerizable monomers that form monomer units other than the first, second and third monomer units include the following polymerizable monomers.

Styrene, o-methylstyrene, and other styrenes and derivatives thereof, and (meth)acrylic acid esters such as methyl (meth)acrylate, n-butyl (meth)acrylate, t-butyl (meth)acrylate, and 2-ethylhexyl (meth)acrylate.

Unsaturated monoolefins such as ethylene, propylene, butylene, and isobutylene; and unsaturated polyenes such as butadiene and isoprene.

Aromatic divinyl compounds; diacrylate compounds linked by alkyl chains; diacrylate compounds linked by alkyl chains containing ether bonds; diacrylate compounds linked by chains containing aromatic groups and ether bonds; polyester type diacrylates; and polyfunctional crosslinking agent. Examples of aromatic divinyl compounds include divinylbenzene and divinylnaphthalene.

Examples of diacrylate compounds linked by alkyl chains include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those obtained by replacing the acrylate of the above compound with methacrylate.

As the polymerizable monomers that form monomer units other than the first, second and third monomer units, styrene is preferable because it is likely to improve the charge stability under a high temperature and high humidity.

The crystalline resin preferably has a second monomer unit, has at least two monomer units selected from among the second monomer units, more preferably has a second monomer unit and a third monomer unit, and still more preferably has a second monomer unit and a third monomer unit. In these cases, the polymerizable monomer forming a second monomer unit is preferably at least one selected from the group consisting of acrylonitrile and methacrylonitrile, and the polymerizable monomer forming a third monomer unit is preferably at least one selected from the group consisting of 2-hydroxyethyl (meth)acrylate and 2-hydroxypropyl (meth)acrylate.

When such polymerizable monomers other than the polymerizable monomer forming a first monomer unit are used in combination, this is preferable because it is easier to form a eutectic with the wax, and the effect of improving uneven gloss on rough paper is more easily exhibited. It is thought that, when polymerizable monomers other than the polymerizable monomer forming a first monomer unit are used in combination, components that are highly compatible with the wax and components that are poorly compatible with the wax coexist in the crystalline resin, which make them more likely to become nuclei for formation of a eutectic with the wax.

In addition, when the toner melts, the electric dipole interaction occurs between the polar groups in the crystalline vinyl resin, and thus the viscosity and elastic modulus of the toner are higher than those of the resin having no polar group.

The second monomer unit has a polar functional group directly bonded to the main chain that contributes greatly to molecular mobility. Therefore, after the toner melts, the storage elastic modulus is higher than that of a resin having no polar group directly bonded to the main chain of the crystalline vinyl resin.

On the other hand, the third monomer unit has a polar hydroxy group at a position away from the main chain. Therefore, after the toner melts, the storage elastic modulus is less likely to be higher than that of a resin having a polar group directly bonded to the main chain of the crystalline vinyl resin.

When the second monomer unit and the third monomer unit coexist, it may be easier to form a eutectic with the wax.

The content of the second monomer unit in the crystalline resin is preferably 3.0 to 25.0 mass %, and more preferably 5.0 to 20.0 mass %.

The content of the third monomer unit in the crystalline resin is preferably 1.0 to 10.0 mass %, and more preferably 3.0 to 7.0 mass %.

The content of monomer units (other monomer units) other than the first, second and third monomer units in the crystalline resin is preferably 10.0 to 60.0 mass %, and more preferably 15.0 to 25.0 mass %. The other monomer units are preferably monomer units based on styrene.

When the crystalline vinyl resin is a vinyl-based resin, the exemplified polymerizable monomer and the polymerization initiator may be used for production. In consideration of efficiency, the polymerization initiator may be used in an amount of from 0.05 parts by mass to 10.00 parts by mass with respect to 100.00 parts by mass of the polymerizable monomer.

Examples of polymerization initiators include the following initiators.

2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoyl azoisobutyronitrile, 2,2′-azobis(2,2,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide, and cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, dicumyl peroxide, α,α′-bis(tert-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioleyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxy neodecanoate, tert-butyl peroxy-2-ethylhexanoate, tert-butyl peroxylaurate, tert-butyl peroxybenzoate, tert-butyl peroxy isopropyl carbonate, di-tert-butyl peroxy isophthalate, tert-butyl peroxy allyl carbonate, tert-amyl peroxy-2-ethylhexanoate, di-tert-butyl peroxy hexahydro terephthalate, di-tert-butylperoxy azelate.

In consideration of charge stability, the acid value of the crystalline resin used as the binder resin is preferably 0 mg KOH/g to 100 mg KOH/g, more preferably 10 mg KOH/g to 60 mg KOH/g, still more preferably 15 mg KOH/g to 50 mg KOH/g, and particularly preferably 20 mg KOH/g to 30 mg KOH/g.

Similarly, the hydroxyl value is preferably 0 mg KOH/g to 100 mg KOH/g, more preferably 0 mg KOH/g to 75 mg KOH/g, still more preferably 0 mg KOH/g to 20 mg KOH/g, and particularly preferably 0 mg KOH/g.

The melting point Tc of the crystalline resin is preferably 50 to 90° C., and more preferably 55 to 70° C.

The content of the crystalline resin based on the mass of the toner particle is 30.0 to 95.0 mass %. When the content of the crystalline resin is within the above range, excellent low-temperature fixability can be achieved. When the content of the crystalline resin is less than 30.0 mass %, the low-temperature fixability decreases. The content of the crystalline resin based on the mass of the toner particle is preferably 40.0 to 90.0 mass %, and more preferably 45.0 to 65.0 mass %.

### <Wax>

The toner particle contains a wax. As the wax, one that is selected as the most suitable wax in combination with the crystalline resin may be used. Examples of waxes include the following waxes.

Hydrocarbon-based waxes such as microcrystalline wax, paraffin wax, and Fischer-Tropsch wax; oxides of hydrocarbon-based waxes such as an oxidized polyethylene wax or block copolymers thereof, waxes whose main component is a fatty acid ester such as carnauba wax; and partially or completely deoxidized fatty acid esters such as deoxidized carnauba wax

In addition, examples thereof include the following: saturated linear fatty acids such as palmitic acid, stearic acid, and montanoic acid; unsaturated fatty acids such as brassidic acid, eleostearic acid, and parinaric acid; saturated alcohols such as stearyl alcohol, aralkyl alcohol, behenyl alcohol, Carnauba alcohol, ceryl alcohol, and melissyl alcohol; polyhydric alcohols such as sorbitol; esters of fatty acids such as palmitic acid, stearic acid, behenic acid, and montanoic acid and alcohols such as stearyl alcohol, aralkyl alcohol, behenyl alcohol, Carnauba alcohol, ceryl alcohol, and melissyl alcohol; fatty acid amides such as linoleic acid amide, oleic acid amide, and lauric acid amide; saturated fatty acid bisamides such as methylene bisstearic acid amide, ethylene biscaprylic acid amide, ethylene bislauric acid amide, and hexamethylene bisstearic acid amide; unsaturated fatty acid amides such as ethylene bisoleic acid amide, hexamethylene bisoleic acid amide, N,N′-dioleyladipic acid amide, and N,N′-dioleyl sebacic acid amide; aromatic bisamides such as m-xylene bisstearic acid amide, and N,N′-distearyl isophthalic acid amide; aliphatic metal salts such as calcium stearate, calcium laurate, zinc stearate, and magnesium stearate (generally known as metal soap); waxes grafted onto aliphatic hydrocarbon-based waxes using vinyl-based monomers such as styrene and acrylic acid; partially esterified products of fatty acids and polyhydric alcohols such as behenic acid monoglyceride; and methyl ester compounds having a hydroxy group obtained by hydrogenating vegetable oils and fats.

The wax preferably includes a hydrocarbon-based wax, and more preferably includes a Fischer-Tropsch wax. In addition, the melting point of the wax is preferably 75° C. to 120° C., more preferably 84 to 120° C., and still more preferably 88 to 110° C.

When the wax contains a hydrocarbon, it is likely to crystallize in the toner, and additionally, the crystallized wax is likely to interact with the crystalline resin having an alkyl group in the side chain. It is thought that this makes it easier for the wax and the crystalline resin to form a eutectic, and thus the image intensity is further improved.

The content of the wax based on the mass of the toner particle is preferably 2.0 to 30.0 mass %, and more preferably 4.0 to 20.0 mass %.

In addition, when the melting point of the wax is Tw (° C.) and the melting point of the crystalline resin is Tc (° C.), it is preferable that Tw and Tc satisfy the relationship of 20≤Tw−Tc≤50. Preferably 25≤Tw−Tc≤45, and more preferably 25≤Tw−Tc≤35. When Tw-Tc is within the above range, it becomes easier to form a continuous phase of a eutectic of the crystalline resin and the wax.

Here, the melting point Tc of the crystalline resin, and the melting point Tw of the wax can be measured using the crystalline resin and the wax separated by a method of separating materials from the toner, which will be described below.

In addition, when the crystalline resin contains the monomer unit represented by the formula (1), the content of the monomer unit represented by the formula (1) based on the mass of the toner particle is defined as W(C), and the content of the wax based on the mass of the toner particle is defined as W(W). In this case, it is preferable that W(C) and W(W) satisfy the relationship of 1.8≤W(C)/W(W)≤7.0.

When W(C)/W(W) is within the above range, this is preferable because the interaction between the crystalline monomer component of the crystalline resin and the wax is likely to occur, and the viscoelasticity of the toner is easily set to be within the above range. More preferably 2.0≤W(C)/W(W)≤5.0, and still more preferably 2.5≤W(C)/W(W)≤4.5.

### <Amorphous Resin>

The toner may further contain, as a binder resin, an amorphous resin in addition to the crystalline resin.

When an amorphous resin is further contained as the binder resin, as the amorphous resin that can be used, known amorphous resins can be used. Examples thereof include the following.

Polyvinyl chloride, phenolic resin, natural resin-modified phenolic resin, natural resin-modified maleic acid resin, polyvinyl acetate, silicone resin, polyester resin, polyurethane resin, polyamide resin, furan resin, epoxy resin, xylene resin, polyvinyl butyral, terpene resin, coumarone-indene resin, petroleum-based resin, and vinyl-based resin.

Among these, it is preferable to include at least one resin selected from the group consisting of a hybrid resin in which a vinyl-based resin and a polyester resin are bonded, a polyester resin and a vinyl-based resin.

An amorphous polyester resin is more preferable. That is, the amorphous resin preferably includes an amorphous polyester resin. When an amorphous polyester resin is used, the interaction with the wax can be reduced and the crystallinity of the wax and the amorphous resin that forms a eutectic with the wax can be improved. This is preferable because it makes it easier to improve the scratch resistance of the image.

As the amorphous polyester resin, a polyester resin that is generally used in a toner can be preferably used. Examples of monomers used in the polyester resin include polyhydric alcohols (di-, tri- or higher hydric alcohols), polycarboxylic acids (di-, tri-, or higher hydric carboxylic acids), anhydrides thereof and lower alkyl esters thereof.

Examples of polyhydric alcohols include the following alcohols.

Examples of dihydric alcohols include the following bisphenol derivatives.

Polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, polyoxypropylene(6)-2,2-bis(4-hydroxyphenyl)propane, and the like.

Examples of other polyhydric alcohols include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexane tetrol, 1,4-sorbitan, pentaerythritol, dipentaerythritol, tripentaerythritol, 1,2,4-butanetriol, 1,2,5-pentantriol, glycerin, 2-methylpropane triol, 2-methyl-1,2,4-butanetriol, trimethylolethane, trimethylolpropane, and 1,3,5-trihydroxymethylbenzene.

These polyhydric alcohols may be used alone or a plurality thereof may be used in combination.

Examples of polycarboxylic acids include the following acids.

Examples of divalent carboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, anhydrides of these acids and lower alkyl esters thereof. Among these, maleic acid, fumaric acid, terephthalic acid, n-dodecenyl succinic acid, and adipic acid are preferably used.

Examples of trivalent or higher carboxylic acid, anhydrides thereof and lower alkyl esters thereof include the following.

1,2,4-benzenetricarboxylic acid (trimellitic acid), 2,5,7-naphthalene tricarboxylic acid, 1,2,4-naphthalene tricarboxylic acid, 1,2,4-butanetricarboxylic acid, 1,2,5-hexane tricarboxylic acid, 1,3-dicarboxy-2-methyl-2-methylenecarboxypropane, 1,2,4-cyclohexane tricarboxylic acid, tetra(methylenecarboxy)methane, 1,2,7,8-octanetetracarboxylic acid, pyromellitic acid, Empol trimer acid, anhydrides thereof and lower alkyl esters thereof.

Among these, 1,2,4-benzenetricarboxylic acid (trimellitic acid) or its derivatives such as anhydrides thereof are preferably used because they are inexpensive and the reaction can be easily controlled.

These polycarboxylic acids may be used alone or a plurality thereof may be used in combination.

A method of producing a polyester resin is not particularly limited, and known methods can be used. For example, the above polyhydric alcohol and polycarboxylic acid are simultaneously added and polymerized through an esterification reaction or a transesterification reaction, and a condensation reaction to produce a polyester resin. In addition, the polymerization temperature is not particularly limited, and is preferably in a range of from 180° C. to 290° C. When a polyester resin is polymerized, for example, a polymerization catalyst such as a titanium-based catalyst, a tin-based catalyst, zinc acetate, antimony trioxide, or germanium dioxide can be used.

The polyester resin used for the amorphous resin is preferably one that is subjected to condensation polymerization using at least one of a titanium-based catalyst and a tin-based catalyst.

The amorphous polyester resin is preferably a condensation polymer of a polyhydric alcohol and a polycarboxylic acid. The polyhydric alcohol preferably includes at least one selected from the group consisting of bisphenol derivatives. The polycarboxylic acid preferably includes at least one selected from the group consisting of fumaric acid, succinic acid, terephthalic acid, and adipic acid. The polycarboxylic acid preferably includes trimellitic acid or its anhydride.

Examples of vinyl resins used as amorphous resins include polymers of polymerizable monomers containing ethylenically unsaturated bonds. The ethylenically unsaturated bond are carbon-carbon double bonds that can undergo radical polymerization, and examples thereof include vinyl groups, propenyl groups, acryloyl groups, and methacryloyl groups.

Examples of polymerizable monomers include the following monomers.

Styrene-based monomers such as styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octyl styrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene; acrylic acids such as acrylate, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate and acrylic acid esters such as acrylate esters; α-methylene aliphatic monocarboxylic acids such as methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate and esters thereof, and acrylonitrile, methacrylonitrile, acrylamide, and the like.

In addition, polymerizable monomers having a hydroxy group such as acrylic acid or methacrylic acid esters, for example, 2-hydroxyethyl acrylate, 2-hydroxyethyl methacrylate, and 2-hydroxypropyl methacrylate, 4-(1-hydroxy-1-methylbutyl)styrene, and 4-(1-hydroxy-1-methylhexyl)styrene. These may be used alone or a plurality thereof may be used in combination.

Among these, it is preferable to use a monomer which is a condensate of acrylic acid or methacrylic acid, such as n-octyl acrylate, dodecyl acrylate, 2-ethylhexyl acrylate, stearyl acrylate, n-octyl methacrylate, dodecyl methacrylate, 2-ethylhexyl methacrylate, or stearyl methacrylate, with an alcohol having 6 to 22 carbon atoms.

These monomers easily interact with long-chain alkyl units having 18 to 30 carbon atoms in the crystalline vinyl resin and can appropriately increase the viscoelasticity.

In addition to the above component, in the vinyl resin, various polymerizable monomers that can undergo vinyl polymerization can be used in combination as necessary.

Examples of polymerizable monomers include the following monomers.

Unsaturated monoolefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalenes; unsaturated dibasic acids such as maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenyl succinic anhydride; half esters of unsaturated basic acids such as methyl maleate half ester, ethyl maleate half ester, butyl maleate half ester, methyl citraconic acid half ester, ethyl citraconic acid half ester, butyl citraconic acid half ester, methyl itaconic acid half ester, methyl alkenylsuccinic acid half ester, methyl fumaric acid half ester, and methyl mesaconic acid half ester; unsaturated basic acid esters such as dimethylmaleic acid and dimethylfumaric acid; anhydrides of α,β-unsaturated acids such as acrylic acid, methacrylic acid, crotonic acid, and cinnamic acid; anhydrides of the α,β-unsaturated acid and lower fatty acids; and polymerizable monomers having a carboxy group such as alkenylmalonic acid, alkenylglutaric acid, and alkenyladipic acid, anhydrides thereof and monoesters thereof.

In addition, the vinyl resin may be a polymer in which crosslinkable polymerizable monomers exemplified below are crosslinked as necessary.

Examples of crosslinkable polymerizable monomers include the following monomers.

Aromatic divinyl compounds; diacrylate compounds linked by alkyl chains; diacrylate compounds linked by alkyl chains containing ether bonds; diacrylate compounds linked by chains containing aromatic groups and ether bonds; polyester type diacrylates; and polyfunctional crosslinking agents.

Examples of aromatic divinyl compounds include divinylbenzene and divinylnaphthalene.

Examples of diacrylate compounds linked by alkyl chains include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those obtained by replacing the acrylate of the above compound with methacrylate.

The vinyl resin is preferably a polymer of polymerizable monomers containing at least one selected from the group consisting of styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octyl styrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, p-nitrostyrene, acrylate, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, phenyl acrylate, methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, acrylonitrile, methacrylonitrile, acrylamide, 2-hydroxyethyl acrylate, 2-hydroxyethyl methacrylate, 2-hydroxypropyl methacrylate, 4-(1-hydroxy-1-methylbutyl)styrene, and 4-(1-hydroxy-1-methylhexyl)styrene.

In addition, the vinyl resin may be a copolymer of monomers including at least one polymerizable monomer selected from the above group and at least one crosslinkable polymerizable monomer selected from the group consisting of divinylbenzene, divinylnaphthalene, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, ethylene glycol dimethacrylate, 1,3-butylene glycol dimethacrylate, 1,4-butanediol dimethacrylate, 1,5-pentanediol dimethacrylate, 1,6-hexanediol dimethacrylate, and neopentyl glycol dimethacrylate. The content of the crosslinkable polymer in the monomer may be about 0.5 mass % to 5.0 mass %.

The vinyl resin may be a resin produced using a polymerization initiator. In consideration of efficiency, the polymerization initiator may be used in an amount of from 0.05 parts by mass to 10.00 parts by mass with respect to 100.00 parts by mass of the polymerizable monomer. Examples of polymerization initiators include the following initiators.

2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoyl azoisobutyronitrile, 2,2′-azobis(2,2,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide, and cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, dicumyl peroxide, α,α′-bis(tert-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioleyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxy neodecanoate, tert-butyl peroxy-2-ethylhexanoate, tert-butyl peroxylaurate, tert-butyl peroxybenzoate, tert-butyl peroxy isopropyl carbonate, di-tert-butyl peroxy isophthalate, tert-butyl peroxy allyl carbonate, tert-amyl peroxy-2-ethylhexanoate, di-tert-butyl peroxy hexahydro terephthalate, and di-tert-butylperoxy azelate.

As the vinyl resin and the polyester resin used to form the hybrid resin in which the vinyl resin and the polyester resin are bonded, the same as those of the vinyl resin and the polyester resin used as the above amorphous resin can be used.

Examples of methods of producing a hybrid resin in which a vinyl-based resin and a polyester resin are bonded include a polymerization method using a compound that can react with both monomers that produce two resins (hereinafter referred to as a “bireactive compound”).

Examples of bireactive compounds include compounds such as fumaric acid, acrylic acid, methacrylic acid, citraconic acid, maleic acid, and dimethyl fumarate. Among these, fumaric acid, acrylic acid, and methacrylic acid are preferably used.

When a hybrid resin in which a vinyl resin and a polyester resin are bonded is used, the content of the vinyl resin in the hybrid resin is preferably 10 mass % or more, 20 mass % or more, 40 mass % or more, 60 mass % or more, or 80 mass % or more, and preferably 100 mass % or less or 90 mass % or less.

In consideration of charge stability, the acid value of the amorphous resin used as the binder resin is preferably 0 mg KOH/g to 100 mg KOH/g, more preferably 10 mg KOH/g to 60 mg KOH/g, still more preferably 15 mg KOH/g to 50 mg KOH/g, and particularly preferably 20 mg KOH/g to 30 mg KOH/g.

Similarly, the hydroxyl value is preferably 0 mg KOH/g to 100 mg KOH/g, more preferably 10 mg KOH/g to 75 mg KOH/g, still more preferably 15 mg KOH/g to 70 mg KOH/g, and particularly preferably 18 mg KOH/g to 60 mg KOH/g.

In consideration of the low-temperature fixability and heat-resistant storability, in the amorphous resin used as the binder resin, the glass transition temperature (Tg) measured by differential scanning calorimetry (DSC) is preferably 40 to 70° C. Tg is more preferably 45° C. to 65° C., and still more preferably 50° C. to 60° C.

When an amorphous resin is used as the binder resin, in order to control the value of d(log G′(T1))/dT and the value of d(log G′(T1+3))/dT−d(log G′(T1))/dT, it is preferable that the melting point Tc (° C.) of the crystalline resin and the glass transition point Tg (° C.) of the amorphous resin satisfy the relationship of |Tc−Tg|≤20. |Tc−Tg|≤15 is more preferable, and |Tc−Tg|≤10 is still more preferable.

The content of the amorphous resin based on the mass of the toner particle is not particularly limited, and is preferably 0.0 to 50.0 mass %, more preferably 10.0 to 45.0 mass %, and still more preferably 15.0 to 40.0 mass %.

When an amorphous resin is further contained as the binder resin, in observation of a cross section of the toner under a transmission electron microscope, a domain matrix structure composed of a matrix containing the crystalline resin and a domain containing the amorphous resin is preferably observed.

When the composition of the crystalline resin and the amorphous resin is appropriately changed, the toner particle can have a domain matrix structure.

The presence of the amorphous domain is preferable because it is easy to improve the crystallinity of the crystalline resin, and the eutectic of the crystalline resin and the wax, and it is easy to increase the image intensity.

In addition, in observation of a cross section of the toner under a transmission electron microscope, the number average diameter of the domain is preferably 0.05 to 3.00 μm, and more preferably 0.10 to 1.00 μm.

### <Other Resins>

In order to improve pigment dispersibility or the like, the binder resin may contain a resin other than the crystalline resin and the amorphous resin as long as the effects of the present disclosure are not impaired. The content of the crystalline resin and the amorphous resin in the binder resin is preferably 80 to 100 mass %, and more preferably 90 to 100 mass %.

Examples of resins include the following resins.

Polyvinyl chloride, phenolic resin, natural resin-modified phenolic resin, natural resin-modified maleic acid resin, polyvinyl acetate, silicone resin, polyester resin, polyurethane resin, polyamide resin, furan resin, epoxy resin, xylene resin, polyvinyl butyral, terpene resin, coumarone-indene resin, petroleum-based resin.

### <Inorganic Filler Particle>

The toner particle may contain inorganic filler particle as necessary in order to adjust viscoelasticity or the like.

As the inorganic filler particle, silica, titanium dioxide, aluminum oxide, metal titanates such as strontium titanate and calcium titanate, calcium carbonate, and kaolin are preferable. Particularly, calcium carbonate and kaolin are preferable in consideration of interaction with the crystalline resin.

The inorganic filler particle is preferably treated with fatty acids. The filler particle is preferably surface-treated with fatty acids because they interact with the alkyl group of the crystalline resin via the fatty acids and thus the filler effect can be more effectively exhibited.

The number average diameter of the primary particle of the inorganic filler particle added internally to the toner particle is preferably 0.15 to 0.45 μm, and more preferably 0.20 to 0.40 μm. The number average diameter of the primary particle of the inorganic filler particle can be measured using a known means such as a scanning electron microscope.

The content of the inorganic filler particle based on the mass of the toner particle is preferably 0 to 20 mass %, and more preferably 0 to 7 mass %.

### <Colorant>

The toner particle may contain a colorant as necessary. Examples of colorants include the following colorants.

Examples of black colorants include carbon black; and colorants that are turned black using a yellow colorant, a magenta colorant and a cyan colorant. As the colorant, a pigment may be used alone, but it is preferable to use a dye and a pigment in combination to improve the clarity in consideration of image quality of a full-color image.

Examples of magenta toner pigments include the following pigments.

C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C.I. pigment violet 19; C.I. vat red 1, 2, 10, 13, 15, 23, 29, 35.

Examples of magenta toner dyes include the following dyes.

C.I. solvent red 1, 3, 8, 23, 24, 25, 27, 30, 49, 81, 82, 83, 84, 100, 109, 121; C.I. disperse red 9; C.I. solvent violet 8, 13, 14, 21, 27; oil-soluble dyes such as C.I. disperse violet 1, and C.I. basic red 1, 2, 9, 12, 13, 14, 15, 17, 18, 22, 23, 24, 27, 29, 32, 34, 35, 36, 37, 38, 39, 40; basic dyes such as C.I. basic violet 1, 3, 7, 10, 14, 15, 21, 25, 26, 27, 28.

Examples of cyan toner pigments include the following pigments.

C.I. pigment blue 2, 3, 15:2, 15:3, 15:4, 16, 17; C.I. vat blue 6; C.I. acid blue 45, and a copper phthalocyanine pigment with 1 to 5 phthalimidemethyl groups substituted on the phthalocyanine framework.

Examples of cyan toner dyes include C.I. solvent blue 70.

Examples of yellow toner pigments include the following pigments.

C.I. pigment yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; and C.I. vat yellow 1, 3, 20.

Examples of yellow toner dyes include C.I. solvent yellow 162.

These colorants may be used alone or in combination, and can also be used in the form of a solid solution. The colorant is selected in consideration of hue angle, chroma, lightness, lightfastness, OHP transparency, and dispersibility in a toner.

The content of the colorant with respect to 100 parts by mass of the binder resin is preferably 0.1 parts by mass to 30.0 parts by mass.

### <Charge Control Agent>

The toner particle may contain a charge control agent as necessary. As the charge control agent, known agents can be used, but metal compounds of aromatic carboxylic acids which are colorless, can charge the toner at a high speed, and can stably retain a certain charge amount are particularly preferable.

Examples of negative charge control agents include metal salicylate compounds, metal naphthoate compounds, dicarboxylic acid metal compounds, polymer type compounds having sulfonic acid or carboxylic acid in the side chain, polymer type compounds having sulfonate or sulfonic acid ester in the side chain, polymer type compounds having carboxylate or carboxylic acid ester in the side chain, boron compounds, urea compounds, silicon compounds, and calixarene.

The charge control agent may be internally or externally added to the toner particle. The content of the charge control agent with respect to 100 parts by mass of the binder resin is preferably 0.2 parts by mass to 10.0 parts by mass, and more preferably 0.5 parts by mass to 10.0 parts by mass.

### <External Additive>

The toner may contain an external additive. For example, an external additive may be externally added to the toner particle to form a toner. As the external additive, inorganic fine particle such as silica, titanium dioxide, aluminum oxide, and metal titanate are preferable. The inorganic fine particle used as the external additive is preferably hydrophobized with a hydrophobic agent such as a silane compound, a silicone oil or a mixture thereof.

The external additive for improving flowability is preferably inorganic fine particle having a BET specific surface area of 50 m²/g to 400 m²/g, and in order to stabilize durability, inorganic fine particle having a BET specific surface area of 10 m²/g to 50 m²/g are preferable. In order to achieve both improved flowability and stable durability, inorganic fine particle having a BET specific surface area in the above range may be used in combination. The toner particle and the external additive can be mixed using a known mixer such as a Henschel mixer.

The content of the external additive with respect to 100 parts by mass of the toner particle is preferably 0.1 to 10.0 parts by mass, and more preferably 2.0 to 7.0 parts by mass.

### <Developer>

Although the toner can be used as a one-component developer, it is preferable to mix it with a magnetic carrier and use it as a two-component developer because images are stably obtained over a long period of time. That is, it is more preferable for the toner to be the above toner, which is a two-component developer containing a toner and a magnetic carrier.

Examples of magnetic carriers include generally known ones, for example, iron powder or iron powder with an oxidized surface; metal particle such as iron, lithium, calcium, magnesium, nickel, copper, zinc, cobalt, manganese, chromium, and rare earth components, and alloy particle thereof or oxide particle thereof, magnetic bodies such as ferrite; and a magnetic body-dispersed resin carrier containing the magnetic body and a binder resin that holds the magnetic body in a dispersed state (so-called resin carrier).

When the toner is mixed with a magnetic carrier and used as a two-component developer, the content of the toner in the two-component developer is preferably from 2.0 mass % to 15.0 mass %, and more preferably from 4.0 mass % to 13.0 mass %.

### <Method of Producing Toner>

The method of producing a toner is not particularly limited, and conventionally known production methods such as a suspension polymerization method, an emulsion aggregation method, a melt-kneading method, and a dissolution suspension method can be used.

A preferable production method for producing a toner is a method of producing a toner including a melt-kneading step in which a toner composition containing a binder resin containing a crystalline resin and an amorphous resin, and a wax is melt-kneaded to obtain a melt-kneaded product, and a pulverizing step in which the melt-kneaded product is cooled and solidified, and the cooled and solidified product is pulverized to obtain a pulverized product. That is, the toner particle is preferably melt-kneaded and pulverized toner particle.

According to the production method, by melt-kneading a mixture in which the proportions of the crystalline resin and the amorphous resin are controlled, a matrix domain structure composed of a matrix containing the crystalline resin and a domain containing the amorphous resin is easily obtained.

The method of producing a toner preferably includes a melt-kneading step in which a mixture containing a crystalline resin and a wax is melt-kneaded, and an annealing step in which the melt-kneaded product obtained in the melt-kneading step is held at a temperature at least 5° C. higher than the melting point of the crystalline resin.

Hereinafter, a toner production procedure in the melt-kneading and pulverizing method will be described.

### <Raw Material Mixing Step>

In the raw material mixing step, as materials constituting the toner particle, for example, a binder resin containing a crystalline resin and an amorphous resin, a wax, and as necessary, other components such as a colorant and a charge control agent are weighed out in predetermined amounts, added and mixed. Examples of mixing devices include a Double Cone Mixer, a V-type mixer, a drum type mixer, a super mixer, a Henschel mixer, a Nauta mixer, and a Mechano hybrid (commercially available from Nippon Coke & Engineering. Co., Ltd.).

### <Melt-Kneading Step>

Next, the mixed materials are melt-kneaded and a wax and the like are dispersed in a binder resin containing a crystalline resin and an amorphous resin. In the melt-kneading step, a batch type kneading machine such as a pressure kneader or a Banbury mixer, or a continuous type kneading machine can be used, and single-screw or twin-screw extruders are mainstream due to the advantage of continuous production. Examples thereof include a KTK type twin-screw extruder (commercially available from Kobelco), a TEM type twin-screw extruder (commercially available from Toshiba Machine Co., Ltd.), a PCM kneading machine (commercially available from Ikegai Corporation), a twin-screw extruder (commercially available from KGK Corporation), Buss Ko-Kneader (commercially available from Buss Corporation), and KNEADEX (commercially available from Nippon Coke & Engineering. Co., Ltd.). In addition, the resin composition obtained by melt-kneading may be rolled with two rollers and cooled with water in a cooling step.

In the melt-kneading step, it is preferable to perform melt-kneading using a twin-screw extruder. According to the kneading temperature in the melt-kneading step, the rotation speed of the screw and the like, it is possible to control the dispersion state of the crystalline resin and the amorphous resin, and the number average diameter of the domain.

The kneading temperature is preferably 110 to 140° C., and more preferably 115 to 130° C. The screw rotation speed during kneading is not particularly limited, and may be appropriately changed according to the device, and is preferably, for example, 200 to 300 rpm.

### <Cooling Step>

The means of the cooling step is not particularly limited. Examples thereof include a method in which the kneaded resin composition is rolled with two rollers or drums and then cooled with a steel belt cooler (commercially available from Nippon Steel Conveyor Co., Ltd.), and a method of performing rolling while cooling using a press roller and a drum including an internal cooling mechanism such as Belt Drum Flaker (commercially available from Nippon Coke & Engineering. Co., Ltd.). In the cooling step, it is preferable to perform rolling while cooling with Belt Drum Flaker.

### <Pulverizing Step>

Next, the cooled resin composition is pulverized to a desired particle diameter in the pulverizing step. In the pulverizing step, for example, after coarsely pulverizing in a pulverizer such as a crusher, a hammer mill, or a feathermill, additionally, fine pulverizing is performed in, for example, Krypton system (commercially available from Kawasaki Heavy Industries, Ltd.), Super Rotor (commercially available from Nisshin Engineering Inc.), Turbo mill (commercially available from Turbo Industry Co., Ltd.) or an air jet type fine pulverizer.

### <Classifying Step>

Then, as necessary, classification may be performed using a classifier such as inertial classification type Elbow Jet (commercially available from Nittetsu Mining Co., Ltd.), centrifugal classification type Turboplex (commercially available from Hosokawa Micron Corporation), TSP separator (commercially available from Hosokawa Micron Corporation), or Faculty (commercially available from Hosokawa Micron Corporation), or a sieving machine to obtain a toner particle.

### <External Addition Step>

The obtained toner particle may be used as a toner without change. A toner may be obtained by applying an external additive to the surface of the toner particle according to an external addition treatment. Examples of methods of applying an external additive according to an external addition treatment include a method in which the classified toner and various known external additives are added in predetermined amounts, and stirred and mixed using a mixing device such as a Double Cone Mixer, a V-type mixer, a drum type mixer, a super mixer, a Henschel mixer, a Nauta mixer, a Mechano hybrid (commercially available from Nippon Coke & Engineering. Co., Ltd.), or Nobilta (commercially available from Hosokawa Micron Corporation) as an external addition machine.

### <Annealing Step>

In the production of the toner, the melt-kneaded product obtained after the melt-kneading step is preferably subjected to annealing in which it is held at a temperature at least 5° C. higher than the melting point of the crystalline resin for 10 minutes or longer. Annealing may be performed after melt-kneading and the cooling step, but is preferably performed before the cooling step. When annealing is performed at a temperature at least 5° C. higher than the melting point of the crystalline resin, eutectic formation of the crystalline resin and the wax is promoted, a continuous phase is formed, the crystalline resin that has not formed a eutectic crystallizes as a discontinuous phase, and it is easier to exhibit an effect of increasing the image intensity.

Specifically, the melt-kneaded product obtained after the melt-kneading step is preferably held at a temperature at least 5° C. higher than the melting point of the crystalline resin. In addition, it is preferable to perform holding at a temperature at least 5° C. lower than the melting point of the wax in order to improve the image intensity and improve the material dispersibility. The retention time is, for example, 10 minutes or longer, preferably 20 to 120 minutes, and more preferably 30 to 60 minutes. In addition, in consideration of production stability, it is more preferable to perform annealing after melt-kneading and before the pulverizing step because the toner particle is less likely to coalesce.

In addition, when the melting point of the wax is Tw (° C.) and the annealing temperature is Ta (° C.), it is preferable that the relationship of Tw-Ta satisfy 2≤Tw−Ta≤20 because it becomes easier to adjust the viscoelasticity of the toner. More preferably 5≤Tw−Ta≤20.

The average circularity of the toner is preferably 0.920 to 0.995, and more preferably 0.960 to 0.990.

The method of measuring various physical properties of the toner and raw materials will be described below.

### <Measurement of Storage Elastic Modulus G′ of Toner>

As a measurement device, a rotating plate type rheometer “ARES” (commercially available from TA INSTRUMENTS) is used. As a measurement sample, a toner sample that is pressure-molded (at 20 Mpa for 30 seconds) into a disk shape with a diameter of 8 mm and a thickness of 2.0±0.3 mm using a tablet forming machine under an environment at 25° C. is used.

The sample is mounted on a parallel plate, heated from room temperature (25° C.) to 60° C. for 15 minutes, and after the shape of the sample is adjusted, the sample is cooled to the viscoelasticity measurement start temperature, measurement starts, and the complex viscosity is measured. In this case, the measurement sample is set so that the initial normal force reaches 0. In addition, as will be described below, in subsequent measurement, the influence of the normal force can be cancelled by turning automatic tension adjustment on (Auto Tension Adjustment ON).

Measurement is performed under the following conditions.
(1) A parallel plate with a diameter of 8 mm is used.
(2) The frequency is 6.28 rad/sec (1.0 Hz).
(3) The initial value of applied strain (Strain) is set to 1.0%.
(4) Measurement is performed at a ramp rate of 2.0° C./min between 40° C. and 150° C.
(5) The measurement interval (Steptime) is 15 sec.

Here, measurement is performed under the following automatic adjustment mode setting conditions. Measurement is performed in an automatic strain adjustment mode (Auto Strain).
(6) The maximum strain (Max Applied Strain) is set to 40.0%.
(7) The maximum torque (Max Allowed Torque) is set to 150.0 g cm, and the minimum torque (Min Allowed Torque) is set to 0.2 g cm.
(8) Strain Adjustment is set to 20.0% of Current Strain. In the measurement, an automatic tension adjustment mode (Auto Tension) is used.
(9) Automatic tension direction (Auto Tension Direction) is set to Compression.
(10) Initial Static Force is set to 10.0 g, and automatic tension sensitivity (Auto Tension Sensitivity) is set to 40.0 g.
(11) Operation conditions for automatic tension (Auto Tension) are a sample modulus of 1.0×10¹ Pa or more.

The measurement results of the storage elastic modulus G′ obtained by the above measurement are plotted as a temperature-storage elastic modulus, with a horizontal axis representing temperature and a vertical axis representing the common log Log G′ of the storage elastic modulus G′. After plotting, a temperature-storage elastic modulus curve is obtained by smoothly connecting points. Next, the slope of the obtained temperature-storage elastic modulus curve is calculated, and a differential curve obtained by differentiating the common log Log G′ with respect to the temperature is graphed. Accordingly, when the storage elastic modulus of the toner at the temperature T (° C.) is defined as G′(T), a graph in which a horizontal axis represents the temperature T, and a vertical axis represents the value d(log G′(T))/dT obtained by differentiating Log G′(T) with respect to the temperature T can be obtained.

On the basis of the differential curve of this graph, a local minimum value is confirmed in a range of 50.0 to 70.0° C., and the temperature at which the local minimum value is reached is defined as a temperature T1 (° C.). Then, the values of d(log G′(T1))/dT, d(log G′(T1+3))/dT, and d(log G′(T1+3))/dT−d(log G′(T1))/dT are obtained.

In addition, the values of G′(T1) and G′(T1+30) are obtained.

Here, when there is a plurality of local minimum values in a range of 50° C. to 70° C., the minimum and smallest value is defined as the local minimum value, and the corresponding temperature is selected as T1.

Here, when it is difficult to draw a smooth line between the temperature-storage elastic modulus plots, smoothing processing may be applied to the measured values to make them connect smoothly. As a smoothing method, a simple moving average method of plotting three values (previous, current, and next values) is used.

### <Observation of Cross Section of Toner, and Measurement of Domain Matrix Structure>

First, a thin piece as a reference sample for abundance is prepared.

After a crystalline resin is sufficiently dispersed in a visible light curable resin (ARONIX LCR series D800), the resin is cured by emitting short-wavelength light. The obtained cured product is cut out with an ultramicrotome including a diamond knife to prepare a 250 nm thin sample. In the same manner, a thin sample of an amorphous resin is also prepared.

In addition, the crystalline resin and the amorphous resin are mixed in a mass ratio of 30/70 and 70/30, and melt-kneaded to prepare a kneaded product. Similarly, these are dispersed in a visible light curable resin, cured and then cut out to prepare a thin sample.

Next, the cut-out sample is observed using a transmission electron microscope (electron microscope JEM-2800, commercially available from JEOL Ltd.) (TEM-EDX) to examine the cross section of this reference sample, and elemental mapping is performed using EDX. The elements to be mapped are carbon, oxygen, and nitrogen.

Mapping conditions are as follows.
Acceleration voltage: 200 kV
Electron beam emission size: 1.5 nm
Live time limit: 600 sec
Dead time: 20 to 30
Mapping resolution: 256×256

On the basis of the spectral intensity (average over a 10 nm square area) of each element, (oxygen element intensity/carbon element intensity) and (nitrogen element intensity/carbon element intensity) are calculated, and a calibration curve is created for the mass ratio of the crystalline resin and the amorphous resin. When the monomer unit of the crystalline resin contains nitrogen atoms, quantitative analysis will be performed in the future using the calibration curve of (nitrogen element intensity/carbon element intensity).

Next, the toner sample is analyzed.

After the toner is sufficiently dispersed in a visible light curable resin (ARONIX LCR series D800), the resin is cured by emitting short-wavelength light. The obtained cured product is cut out with an ultramicrotome including a diamond knife to prepare a 250 nm thin sample.

Next, the cut-out sample is observed using a transmission electron microscope (electron microscope JEM-2800, commercially available from JEOL Ltd.) (TEM-EDX). A cross-section image of the toner is obtained and elemental mapping is performed using EDX. The elements to be mapped are carbon, oxygen, and nitrogen.

Here, the cross section of the toner to be observed is selected as follows. First, the cross-sectional area of the toner is obtained from the toner cross-section image, and the diameter (equivalent circle diameter) of a circle having the same area as the cross-sectional area is obtained. Only toner cross-section images in which the absolute value of the difference between the equivalent circle diameter and the weight-average particle diameter (D4) of the toner is within 1.0 μm are observed.

For the observed image, the cross section of the toner particle is divided into 10 nm square areas. In each area, based on the spectral intensity (average over a 10 nm square) of each element, (oxygen element intensity/carbon element intensity) and/or (nitrogen element intensity/carbon element intensity) are calculated, and the crystalline resin and the amorphous resin are distinguished by comparing with the calibration curve. When the crystalline resin or the amorphous resin is contained in an amount of 80 mass % or more, the 10 nm square area is considered to be occupied by the crystalline resin or the amorphous resin.

Here, when an area group occupied by the amorphous resin is isolated and surrounded by an area group of the crystalline resin, the area occupied by the amorphous resin is identified as a domain containing the amorphous resin. In addition, when the area group of the crystalline resin exists as a continuous phase, the continuous phase is identified as a matrix containing the crystalline resin. It is checked whether the toner particle has such a matrix and domain, and it is identified that the toner particle has a domain matrix structure composed of a matrix containing the crystalline resin and a domain containing the amorphous resin.

The areas of the matrix and the domain identified as described above are calculated, and the proportion of the domain area to the total area of the matrix and the domain can be calculated.

Then, binarization processing is performed and the domain particle diameter in the toner cross-section image is measured. The particle diameter is defined as the major axis of the domain. For 10 toner cross sections, the domain particle diameters are measured at 10 points on each toner cross section, and the arithmetic average value of a total of 100 domain particle diameters is defined as the number average diameter (m) of the domains.

Here, as crystalline resin and amorphous resin samples, crystalline resins and amorphous resins separated from the toner by the following method can be used.

<Method of Separating Materials from Toner>

Using the difference in solubility of the materials contained in the toner in a solvent, the materials can be separated from the toner.

First separation: a toner is dissolved in methyl ethyl ketone (MEK) at 23° C., and soluble components (amorphous resin) and insoluble components (crystalline resin, wax, colorant, inorganic filler particle, etc.) are separated.

Second separation: the insoluble components (crystalline resin, wax, colorant, inorganic filler particle, etc.) obtained in the first separation are dissolved in MEK at 100° C., and soluble components (crystalline resin, wax) and insoluble components (colorant, inorganic filler particle, etc.) are separated.

Third separation: the soluble components (crystalline resin, wax) obtained in the second separation are dissolved in chloroform at 23° C., and soluble components (crystalline resin) and insoluble components (wax) are separated.

### (Measurement of Content of Crystalline Resin and Amorphous Resin in Binder Resin and Inorganic Filler Particle in Toner)

In each separation step performed by the above separation, when the mass of the soluble components and insoluble components is measured, the content of the crystalline resin and the amorphous resin in the binder resin in the toner is calculated.

In addition, the amount of the inorganic filler particle in the toner is calculated by X-ray fluorescence measurement. The X-ray fluorescence for each element is measured according to JIS K 0119-1969. Details are as follows.

As the measurement device, a wavelength dispersive X-ray fluorescence analyzer (product name: Axios, commercially available from PANalytical) and a dedicated bundled software (product name: SuperQ ver.4.0F, commercially available from PANalytical) for setting measurement conditions and analyzing measurement data are used. In addition, Rh is used as the anode of the X-ray tube, the measurement atmosphere is a vacuum, the measurement diameter (collimator mask diameter) is 27 mm, and the measurement time is 10 seconds. Here, with this device, when light elements are measured, they are detected by a proportional counter (PC), and when heavy elements are measured, they are detected by a scintillation counter (SC).

As the measurement sample, 4 g of the toner is placed in a dedicated aluminum ring for pressing and flattened. Then, pressurization is performed at 20 Mpa for 60 seconds using a tablet molding and compression machine (product name: BRE-32, commercially available from Maekawa Testing Machine MFG. Co., Ltd.), and pellets molded to have a thickness of 2 mm and a diameter of 39 mm are used. Measurement is performed under the above conditions, the element is identified on the basis of the peak position of the obtained X-ray, and the density of the element is calculated from the count rate (unit: cps), which is the number of X-ray photons per unit time.

For example, when the inorganic filler particle is a fine calcium carbonate particle, with respect to 100 parts by mass of the toner particle, 0.1 parts by mass, 1.0 part by mass, and 2.5 parts by mass of fine calcium carbonate particles are mixed with the toner particles, and these mixtures are used as samples for the calibration curve. For each sample, the tablet molding and compression machine is used to prepare sample pellets for the calibration curve as described above, and the count rate (unit: cps) of Si-Kα rays observed at a diffraction angle (2θ) of 109.080 when PET is used as the analyzing crystal is measured.

In this case, the acceleration voltage and the current value of the X-ray generating device are 24 kV and 100 mA, respectively. A linear calibration curve is obtained with a vertical axis representing the obtained count rate of X-ray and a horizontal axis representing the amount of fine calcium carbonate particle in the sample for the calibration curve. Next, the toner to be analyzed is formed into pellets using the tablet molding and compression machine as described above, and the count rate of the Ca-Kα rays is measured. Then, the content of the fine calcium carbonate particle in the toner particle is calculated from the calibration curve.

### <Method of Identifying Monomer Units Constituting Crystalline Resin and Amorphous Resin, and Measuring Content of Monomer Units>

Identification of monomer units constituting the crystalline resin and the amorphous resin and measurement of the content of monomer units are performed by ¹H-NMR under the following conditions.
Measurement device: FT NMR device JNM-EX400 (commercially available from JEOL Ltd.)
Measurement frequency: 400 MHz
Pulse condition: 5.0 s
Frequency range: 10,500 Hz
Cumulative number of measurements: 64
Measurement temperature: 30° C.
Sample: 50 mg of a measurement sample is put into a sample tube with an inner diameter of 5 mm, deuterated chloroform (CDCl₃) is added as a solvent, and the sample is dissolved in a thermostatic chamber at 40° C. for preparation.

From the obtained ¹H-NMR chart, a peak independent of peaks attributed to components of other monomer units is selected from among peaks attributed to components of the first monomer unit, and an integration value S₁ of this peak is calculated. Similarly, a peak independent of peaks attributed to components of other monomer units is selected from among peaks attributed to components of the second monomer unit, and an integration value S₂ of this peak is calculated.

When the resin further has a third monomer unit, a peak independent of peaks attributed to components of other monomer units is selected from among peaks attributed to components of the third monomer unit, and an integration value S₃ of this peak is calculated.

When the resin further has another monomer unit such as a monomer unit X, an integration value Sx is calculated in the same manner.

The content of the first monomer unit is calculated using the integration values S₁, S₂, S₃ and Sₓ, as follows. Here, n₁, n₂, n₃, and nₓ are the numbers of hydrogen atoms in the components to which the peak of interest for each site belongs.

$$Content of first monomer unit ( mol \% ) = \{ ( {S}_{1} / {n}_{1} ) / ( ( {S}_{1} / {n}_{1} ) + ( {S}_{2} / {n}_{2} ) + ( {S}_{3} / {n}_{3} ) … + ( {S}_{x} / {n}_{x} ) ) \} \times 100$$

Similarly, the contents of the second monomer unit and the third monomer unit are calculated as follows.

$$Content of second monomer unit ( mol \% ) = \{ ( {S}_{2} / {n}_{2} ) / ( ( {S}_{1} / {n}_{1} ) + ( {S}_{2} / {n}_{2} ) + ( {S}_{3} / {n}_{3} ) … + ( {S}_{x} / {n}_{x} ) ) \} \times 100 \\ Content of third monomer unit ( mol \% ) = \{ ( {S}_{3} / {n}_{3} ) / ( ( {S}_{1} / {n}_{1} ) + ( {S}_{2} / {n}_{2} ) + ( {S}_{3} / {n}_{3} ) … + ( {S}_{x} / {n}_{x} ) ) \} \times 100$$

Here, in the crystalline resin and the amorphous resin, for example, when a polymerizable monomer containing no hydrogen atom is used as a component other than vinyl groups, the measurement nucleus is set to ¹³C using ¹³C-NMR, measurement is performed in a single pulse mode, and calculation is performed in the same manner as for ¹H-NMR. On the basis of the molecular weight of the monomer units, it is possible to convert from mol % to mass %.

### <Method of Measuring Melting Point and Endothermic Peak and Endothermic Amount of Toner, Resin and the Like>

The melting point and the endothermic peak and the endothermic amount of the toner, the resin and the like are measured using DSC Q1000 (commercially available from TA Instruments) under the following conditions.
Ramp rate: 10° C./min
Measurement start temperature: 20° C.
Measurement end temperature: 180° C.

The melting points of indium and zinc are used to correct the temperature of the device detection unit, and heat of fusion of indium is used to correct the amount of heat. Specifically, 5 mg of a sample is accurately weighed out and put into an aluminum pan, and differential scanning calorimetry is performed. As a reference, an empty silver pan is used. The peak temperature of the maximum endothermic peak in the first heating process is defined as the melting point. Here, the maximum endothermic peak is the peak with the largest endothermic amount when there is a plurality of peaks. In addition, the endothermic amount of the maximum endothermic peak is obtained. When DSC measurement is performed on each material alone separated from the toner described above, the attribution of each peak can be determined.

On the basis of the measurement using the toner as a sample and the measurement using the wax separated from the toner as a sample, ΔH(T) and ΔH(W) can be calculated.

In addition, the melting point Tc of the crystalline resin, and the melting point Tw of the wax can be obtained.

### <Method of Measuring Glass Transition Temperature of Toner, Resin and the Like>

As in the measurement of the melting point, and the endothermic peak and the endothermic amount of the toner, the resin, and the like, measurement is performed using DSC Q1000 (commercially available from TA Instruments) under the following conditions. Measurement is performed at a ramp rate of 10° C./min in a measurement range of 20 to 180° C. Here, in the measurement, the resin is first heated to 200° C., held for 10 minutes, then cooled to 20° C., and then heated again. In this second heating process, a specific heat change is obtained in a temperature range of 20 to 100° C. The point of intersection between the line at the midpoint between the baselines before and after a specific heat change occurs in this case and the differential thermal curve is defined as the glass transition temperature (Tg) of the toner, the resin and the like.

### <Method of Measuring Softening Point (Tm) of Resin>

The softening point of the resin is measured using a constant load extrusion type capillary rheometer “Flow characteristic evaluation device Flowtester CFT-500D” (commercially available from Shimadzu Corporation) according to the device bundled manual. In this device, a constant load is applied from above the measurement sample using a piston, the measurement sample filled in a cylinder is heated and melts, the molten measurement sample is extruded from a die at the bottom of the cylinder, and a flow curve showing the relationship between the amount of piston drop and the temperature in this case can be obtained.

In addition, the “melting temperature in the ½ method” described in the manual bundled in “Flow characteristic evaluation device Flowtester CFT-500D” is defined as the softening point. Here, the melting temperature in the ½ method is calculated as follows.

First, half of the difference between the amount of piston drop when the outflow ends (outflow end point, Smax) and the amount of piston drop when the outflow starts (minimum point, Smin) is calculated (this is referred to as X. X=(Smax−Smin)/2). Thus, the temperature on the flow curve when the amount of piston drop is the sum of X and Smin is the melting temperature in the ½ method.

A measurement sample obtained by compression-molding 1.0 g of the resin under an environment at 25° C. using a tablet molding and compression machine (for example, NT-100H, commercially available from NPa System Co., Ltd.) at about 10 Mpa for about 60 seconds to have a cylindrical shape with a diameter of about 8 mm is used.

A specific measurement operation is performed according to the manual bundled in the device.

The measurement conditions for CFT-500D are as follows.
Test mode: heating time
Start temperature: 50° C.
Saturated temperature: 200° C.
Measurement interval: 1.0° C.
Ramp rate: 4.0° C./min
Piston cross-sectional area: 1.000 cm²
Test load (piston load): 10.0 kgf (0.9807 MPa)
Preheating time: 300 seconds
Diameter of hole of die: 1.0 mm
Length of die: 1.0 mm

### <Method of Measuring Weight-Average Particle Diameter (D4) of Toner (Particle)>

The weight-average particle diameter (D4) of the toner (particle) is calculated by using a precision particle size distribution measurement device “Coulter counter Multisizer 3” (registered trademark, commercially available from Beckman Coulter, Inc.) including a 100 μm aperture tube using a pore electrical resistance method and a dedicated bundled software “Beckman Coulter Multisizer 3 Version3.51” (commercially available from Beckman Coulter, Inc.) for setting measurement conditions and analyzing measurement data, measuring 25,000 channels as an effective number of measurement channels, and analyzing measurement data.

As an electrolyte aqueous solution used for the measurement, a solution prepared by dissolving special grade sodium chloride in deionized water to a concentration of about 1 mass %, for example, “ISOTON II” (commercially available from Beckman Coulter, Inc.) can be used. Here, before performing the measurement and analysis, dedicated software is set as follows.

In the “Change standard measurement method (SOM) screen” in the dedicated software, the total count in the control mode is set to 50,000 particles, the number of measurements is set to 1, and the Kd value is set to a value obtained using “standard particle 10.0 μm” (commercially available from Beckman Coulter, Inc.). When the threshold/noise level measurement button is pressed, the threshold and the noise level are automatically set. In addition, the current is set to 1,600 μA, the gain is set to 2, the electrolyte solution is set to ISOTON II, and the box “flush aperture tube after measurement” is checked. In the “Setting screen for converting pulse to particle diameter” in the dedicated software, set the bin interval to the logarithmic particle diameter, set the particle diameter bin to 256 particle diameter bin, and set the particle diameter range to from 2 μm to 60 μm. A specific measurement method is as follows.
(1) About 200 mL of an electrolyte aqueous solution is put into a 250 mL round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.
(2) About 30 mL of an electrolyte aqueous solution is put into a 100 mL flat-bottom glass beaker, and about 0.3 mL of a diluted solution prepared by diluting “Contaminon N” (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) as a dispersing agent in 3 mass times of deionized water is added thereto.
(3) Two oscillators with an oscillating frequency of 50 kHz and with phases shifted by 180 degrees are incorporated, a predetermined amount of deionized water is put into a water tank of an ultrasonic disperser “Ultrasonic Dispersion System Tetora150” with an electrical output of 120 W (commercially available from Nikkaki Bios Co., Ltd.), and about 2 mL of Contaminon N is added to this water tank.
(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.
(5) While ultrasonic waves are emitted to the electrolyte aqueous solution in the beaker in (4), about 10 mg of the toner (particle) is added little by little to and dispersed in the electrolyte aqueous solution. In addition, an ultrasonic dispersion treatment is additionally continued for 60 seconds. Here, in the ultrasonic dispersion, the water temperature in the water tank is appropriately adjusted to be from 10° C. to 40° C.
(6) In the round-bottom beaker in (1) placed in the sample stand, the electrolyte aqueous solution in (5) in which the toner (particle) is dispersed using a pipette is added dropwise, and the measurement density is adjusted to about 5%. In addition, the measurement is performed until the number of measurement particles reaches 50,000.
(7) The measurement data is analyzed using dedicated software bundled in the device, and the weight-average particle diameter (D4) is calculated. Here, when graph/vol % is set in the dedicated software, the “average diameter” on the analysis/volume statistics (arithmetic average) screen is the weight-average particle diameter (D4).

### <Method of Measuring Acid Value of Resin>

The acid value is the number of mg of potassium hydroxide required to neutralize an acid contained in 1 g of a sample. The acid value of the crystalline resin and the amorphous resin is measured according to JIS K 0070-1992, and specifically, according to the following procedure.

### (1) Preparation of Reagent

1.0 g of phenolphthalein is dissolved in 90 mL of ethyl alcohol (95 vol %), deionized water is added to make 100 mL, and thereby a phenolphthalein solution is obtained. 7 g of special grade potassium hydroxide is dissolved in 5 mL of water, and ethyl alcohol (95 vol %) is added to make 1 L. In order to prevent contact with carbon dioxide gas and the like, the mixture is put into an alkali-resistant container, left for 3 days, and then filtered to obtain a potassium hydroxide solution. The obtained potassium hydroxide solution is stored in an alkali-resistant container. The factor of the potassium hydroxide solution is determined from the amount of the potassium hydroxide solution required for neutralization when 25 mL of 0.1 mol/L hydrochloric acid is put into a conical flask, several drops of the phenolphthalein solution are added, and titrating with the potassium hydroxide solution is performed. The 0.1 mol/L hydrochloric acid prepared according to JIS K 8001-1998 is used.

### (2) Operation

### (A) Main Test

2.0 g of the pulverized crystalline resin or amorphous resin sample is accurately weighed out in a 200 mL conical flask, 100 mL of a mixed solution of toluene/ethanol (2:1) is added, and the mixture is dissolved over 5 hours. Next, several drops of the phenolphthalein solution are added as an indicator, and titration is performed using the potassium hydroxide solution. Here, the titration end point is when a light red color of the indicator lasts for about 30 seconds.

### (B) Blank Test

The titration is performed in the same operation as above except that no sample is used (that is, only a mixed solution of toluene/ethanol (2:1) is used).

(3) The Obtained Result is Substituted into the Following Formula to Calculate the Acid Value.

$$A = [ ( C - B ) \times f \times 5.61 ] / S$$

Here, A: acid value (mg KOH/g), B: amount of the potassium hydroxide solution added in the blank test (mL), C: amount of the potassium hydroxide solution added in the main test (mL), f: factor of the potassium hydroxide solution, S: mass of the sample (g).

### <Method of Measuring Hydroxyl Value of Resin>

The hydroxyl value is the number of mg of potassium hydroxide required to neutralize acetic acid bonded to a hydroxyl group when 1 g of a sample is acetylated. The hydroxyl value is measured according to JIS K 0070-1992, and specifically, according to the following procedure.

### (1) Preparation of Reagent

25 g of special grade acetic anhydride is put into a 100 mL volumetric flask, pyridine is added to make a total amount of 100 mL, and the mixture is sufficiently shaken to obtain an acetylation reagent. In order to prevent contact with moisture, carbon dioxide gas and the like, the obtained acetylation reagent is stored in a brown bottle.

1.0 g of phenolphthalein is dissolved in 90 mL of ethyl alcohol (95 vol %), deionized water is added to make 100 mL, and thereby a phenolphthalein solution is obtained.

35 g of special grade potassium hydroxide is dissolved in 20 mL of water, and ethyl alcohol (95 vol %) is added to make 1 L. In order to prevent contact with carbon dioxide gas and the like, the mixture is put into an alkali-resistant container, left for 3 days, and then filtered to obtain a potassium hydroxide solution. The obtained potassium hydroxide solution is stored in an alkali-resistant container. The factor of the potassium hydroxide solution is determined from the amount of the potassium hydroxide solution required to neutralize when 25 mL of 0.5 mol/L hydrochloric acid is put into a conical flask, several drops of the phenolphthalein solution are added, and titration with the potassium hydroxide solution is performed. The 0.5 mol/L hydrochloric acid prepared according to JIS K 8001-1998 is used.

### (2) Operation

### (A) Main Test

1.0 g of the pulverized crystalline resin or amorphous resin sample is accurately weighed out in a 200 mL round-bottom flask, and 5.0 mL of the acetylation reagent is accurately added thereto using a volumetric pipette. In this case, when the sample does not easily dissolve in the acetylation reagent, a small amount of special grade toluene is added to dissolve the sample.

A small funnel is placed on the mouth of the flask, and about 1 cm of the bottom of the flask is immersed and heated in a glycerin bath at about 97° C. In this case, in order to prevent the temperature of the neck of the flask from increasing due to heat of the bath, it is preferable to cover the base of the neck of the flask with a piece of cardboard with a round hole.

After 1 hour, the flask is removed from the glycerin bath and cooled. After cooling, 1 mL of water is added from the funnel and shaken to hydrolyze acetic anhydride. For more complete hydrolysis, the flask is heated again in the glycerin bath for 10 minutes. After cooling, the funnel and flask walls are washed with 5 mL of ethyl alcohol.

Several drops of the phenolphthalein solution are added as an indicator, and titration with the potassium hydroxide solution is performed. Here, the titration end point is when a light red color of the indicator lasts for about 30 seconds.

### (B) Blank Test

The titration is performed in the same operation as above except that no crystalline resin or amorphous resin sample is used.

(3) The Obtained Result is Substituted into the Following Formula to Calculate the Hydroxyl Value.

$$A = [ \{ ( B - C ) \times 28.05 \times f \} / S ] + D$$

Here, A: hydroxyl value (mg KOH/g), B: amount of the potassium hydroxide solution added in the blank test (mL), C: amount of the potassium hydroxide solution added in the main test (mL), f: factor of the potassium hydroxide solution, S: mass of the sample (g), D: acid value of the sample (mg KOH/g).

### <Measurement of Average Circularity>

The average circularity of the toner is measured using a flow type particle image analyzing device “FPIA-3000” (commercially available from Sysmex Corporation) under measurement and analysis conditions during a calibration operation.

A specific measurement method is as follows.

First, about 20 mL of deionized water from which impurity solid components have been removed in advance is put into a glass container. About 0.2 mL of a diluted solution prepared by diluting “Contaminon N” (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) as a dispersing agent in about 3 mass times of deionized water is added thereto.

In addition, about 0.02 g of the measurement sample is added, and a dispersion treatment is performed using an ultrasonic disperser for 2 minutes to obtain a dispersion for measurement. In this case, the dispersion is appropriately cooled so that the temperature of the dispersion is from 10° C. to 40° C. As the ultrasonic disperser, a desktop ultrasonic cleaner/disperser with an oscillating frequency of 50 kHz and an electrical output of 150 W (“VS-150” (commercially available from Velvo-Clear)) is used, a predetermined amount of deionized water is put into a water tank, and about 2 mL of Contaminon N is added to the water tank.

For the measurement, the flow type particle image analyzing device with a standard objective lens (10×) mounted thereon is used, and a particle sheath “PSE-900A” (commercially available from Sysmex Corporation) is used as the sheath liquid. The dispersion prepared according to the procedure is introduced into the flow type particle image analyzing device, and in the HPF measurement mode, 3,000 toners are measured in a total count mode.

In addition, the binarization threshold during particle analysis is set to 85%, the analyzed particle diameter is limited to an equivalent circle diameter of 1.985 μm or more and less than 39.69 μm, and the average circularity of the toner is calculated.

Upon the measurement, before the start of the measurement, automatic focus adjustment is performed using standard latex particles (“RESEARCH AND TEST PARTICLES Latex Microsphere Suspensions 5200A” (commercially available from Duke Scientific) diluted with deionized water) Then, it is preferable to perform focus adjustment every two hours from the start of the measurement.

Here, in examples, a flow type particle image analyzing device that has been calibrated by Sysmex Corporation and has received a calibration certificate issued by Sysmex Corporation is used. The measurement is performed under measurement and analysis conditions when calibration certification was received, except that the analyzed particle diameter is limited to an equivalent circle diameter of 1.985 μm or more and less than 39.69 μm.

<Method of Separating Toner Particle from Toner>

The external additives can be separated by the following method to obtain a toner particle. The obtained toner particle is used, materials are separated by the above method, and the content can be measured.

160 g of sucrose (commercially available from Kishida Chemical Co., Ltd.) is added to 100 mL of deionized water and dissolved in hot water bath to prepare a sucrose concentrated solution. 31 g of the sucrose concentrated solution and 6 mL of Contaminon N (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) were put into a centrifugation tube to prepare a dispersion.

1.0 g of the toner is added to this dispersion, and toner clumps are disintegrated with a spatula or the like. The centrifugation tube is shaken in a shaker (AS-1N commercially available from As One Corporation) at 350 spm (strokes per min) for 20 min. After shaking, the solution is transferred to a swing rotor glass tube (50 mL), and separated using a centrifugal separator (H-9R, commercially available from Kokusan Co., Ltd.) under conditions of 3,500 rpm and 30 min. According to this operation, the toner particle and the removed external additive are separated.

It is visually confirmed that the toner particle and the aqueous solution are sufficiently separated, and the toner particle separated at the top layer are collected with a spatula or the like. The collected toner is filtered through a vacuum filter and then dried in a dryer for 1 hour or longer to obtain the toner particle. This operation is performed a plurality of times to secure a required amount.

### <Method of Calculating SP Value>

The SP values of the crystalline resin and the wax are determined as follows according to the calculation method proposed by Fedors.

For each resin or wax, the evaporation energy (Δei) (cal/mol) and the molar volume (Δvi) (cm³/mol) for each atom or atom group in the molecular structure are obtained from the table in “Polym. Eng. Sci., 14(2), 147-154 (1974),” and (4.184×ΣΔei/ΣΔvi)⁰⁵ is defined as the SP value (J/cm³)^{0.5}.

### EXAMPLES

The basic configuration and features of the present disclosure have been described above, but the present disclosure will be described below in detail with reference to examples. However, the present disclosure is not limited thereto. Here, unless otherwise specified, parts and % are based on mass.

### <Production Example of Crystalline Resin 1>

| | |
|---|---|
| Solvent: toluene | 100.0 parts |
| Monomer composition | 100.0 parts |

(the monomer composition is a mixture containing the following behenyl acrylate, styrene, acrylonitrile, and 2-hydroxyethyl acrylate at the following proportions)

| | | |
|---|---|---|
| (behenyl acrylate | 60.0 | parts) |
| (styrene | 20.0 | parts) |
| (acrylonitrile | 15.0 | parts) |
| (2-hydroxyethyl acrylate | 5.0 | parts) |
| Polymerization initiator | 0.5 | parts |

[t-Butyl Peroxypivalate (Perbutyl PV, Commercially Available from NOF Corporation)]

The above materials were put into a reaction container including a reflux cooling tube, a stirrer, a thermometer, and a nitrogen inlet tube under a nitrogen atmosphere. While stirring the inside of the reaction container at 200 rpm, heating was performed to 70° C., and a polymerization reaction was performed for 12 hours to obtain a solution in which the polymer of the monomer composition was dissolved in toluene.

Subsequently, the solution was cooled to 25° C., and the solution was then put into 1000.0 parts of methanol with stirring to precipitate a methanol insoluble component. The obtained methanol insoluble component was filtered off, additionally washed with methanol, then vacuum-dried at 40° C. for 24 hours to obtain a crystalline resin 1. The melting point (Tc) of the obtained crystalline resin 1 was 61° C.

### <Production Example of Crystalline Resins 2 to 5>

Crystalline resins 2 to 5 were obtained by performing the reaction in the same manner as in the production example of the crystalline resin 1 except that the monomers and the parts by mass thereof were changed as shown in Table 1.

### <Production Example of Crystalline Resin 6>

For 1,6-hexanediol (50 mol %; 11.82 parts by mass) and adipic acid (50 mol %; 14.61 parts by mass), in a reaction chamber including a cooling tube, a stirrer, a nitrogen inlet tube, and a thermocouple, the above materials were weighed out. Next, the inside of the flask was purged with nitrogen gas, the temperature was then gradually raised with stirring, and the reaction was performed for 3 hours while stirring at a temperature of 140° C.

0.5 mass % of stannous 2-ethylhexanoate with respect to a total mass of the monomers was added, the above materials were then added, the pressure in the reaction chamber was lowered to 8.3 kPa, and while maintaining the temperature at 200° C., the reaction was performed for 4 hours, the pressure in the reaction chamber was then gradually released to return to atmospheric pressure, and thereby a crystalline resin 6 was obtained.

### <Production Example of Crystalline Resin 7>

A crystalline resin 7 was obtained by performing the reaction in the same manner as in the production example of the crystalline resin 6 except that 1,12-dodecanediol was used in place of hexanediol, sebacic acid was used in place of adipic acid, and the parts by mass were changed so that each mol % was set to 50 mol %.

TABLE 1

| | First monomer | | | | | | | | | | |
|---|---|---|---|---|---|---|---|---|---|---|---|
| | unit | | | | | | | | | | |
| | | | Number of | | | | | | | Physical | |
| | | | carbon atoms | Other monomer | | Second monomer | | Third monomer | | properties | |
| Crystalline | | | of alkyl group | unit | | unit | | unit | | Melting | |
| resin | | Parts by | R1 in formula | | Parts by | | Parts by | | Number | point | SP |
| No | Monomer | mass | (1) | Monomer | mass | Monomer | mass | Monomer | of parts | Tc/° C. | value |
| 1 | BEA | 60.0 | 22 | St | 20.0 | ACN | 15.0 | HEA | 5.0 | 61 | 20.5 |
| 2 | BEA | 60.0 | 22 | St | 20.0 | ACN | 15.0 | HEMA | 5.0 | 62 | 20.4 |
| 3 | BEA | 60.0 | 22 | St | 20.0 | ACN | 15.0 | HPMA | 5.0 | 60 | 20.4 |
| 4 | BEA | 100.0 | 22 | — | — | — | — | — | — | 65 | 18.3 |
| 5 | BEA | 90.0 | 22 | — | — | ACN | 5.0 | MA | 5.0 | 60 | 19.1 |
| 6 | 1,6- | 50 mol % | — | Adipic acid | 50 mol % | — | — | — | — | 68 | 20.8 |
| | hexanediol | | | | | | | | | | |
| 7 | 1,12- | 50 mol % | — | Sebacic acid | 50 mol % | — | — | — | — | 83 | 19.4 |
| | dodecanediol | | | | | | | | | | |

The unit of the SP value is (J/cm³)^{0.5}.

The abbreviations in Table 1 are as follows. Here, in Table 1, the parts by mass for 1,6-hexanediol, 1,12-dodecanediol, adipic acid, and sebacic acid are mol %.
BEA: behenyl acrylate
St: styrene
ACN: acrylonitrile
HEA: 2-hydroxyethyl acrylate
HEMA: 2-hydroxyethyl methacrylate
HPMA: 2-hydroxypropyl methacrylate
MA: methacrylic acid

### <Production Example of Amorphous Resin 1>

The following materials were put into a reaction container including a reflux cooling tube, a stirrer, a thermometer, and a nitrogen inlet tube under a nitrogen atmosphere.
Polyoxyethylene(2.0)-2,2-bis(4-hydroxyphenyl)propane: 72.9 parts (50.0 mol parts)
Terephthalic acid: 15.0 parts (25.0 mol parts)
Adipic acid: 7.9 parts (15.0 mol parts)
Fumaric acid: 4.2 parts (10.0 mol parts)
Titanium tetrabutoxide: 2.0 parts

Next, the inside of the flask was purged with nitrogen gas, the temperature was then gradually raised with stirring, the mixture was stirred at a temperature of 200° C., and while the produced water was distilled off, the reaction was performed for 2 hours. In addition, the pressure in the reaction chamber was lowered to 8.3 kPa, held for 1 hour, then cooled to 180° C., and returned to atmospheric pressure (first reaction step).
Trimellitic anhydride: 8.2 parts (2.5 mol parts)
Tert-butylcatechol (polymerization inhibitor): 0.1 parts

Then, the above materials were added, the pressure in the reaction chamber was lowered to 8.3 kPa, the reaction was performed for 4 hours while maintaining the temperature at 150° C., the temperature was lowered to stop the reaction (second reaction step), and thereby an amorphous resin 1 was obtained. The glass transition temperature Tg of the amorphous resin was 56° C.

TABLE 2

| | Polymerizable | | Polymerizable | | Polymerizable | | Polymerizable | |
|---|---|---|---|---|---|---|---|---|
| Amorphous | monomer 1 | | monomer 2 | | monomer 3 | | monomer 4 | |
| resin | Type | mol % | Type | mol % | Type | mol % | Type | mol % |
| 1 | BPA-EO | 50.0 | TPA | 25.0 | FA | 10.0 | AA | 15.0 |

The abbreviations in Table 2 are as follows.
BPA-EO: polyoxyethylene(2.0)-2,2-bis(4-hydroxyphenyl)propane
TPA: terephthalic acid
FA: fumaric acid
AA: adipic acid

### ≤Wax>

The following waxes were used.

TABLE 3

| Wax | Type | Melting point Tw/° C. |
|---|---|---|
| Wax 1 | Fischer-Tropsch wax | 90 |
| Wax 2 | Fischer-Tropsch wax | 77 |
| Wax 3 | Fischer-Tropsch wax | 85 |
| Wax 4 | Fischer-Tropsch wax | 105 |
| Wax 5 | Fischer-Tropsch wax | 115 |
| Wax 6 | Ester wax (Behenyl behenate) | 75 |

### <Production Example of Toner Particle 1>

Crystalline resin 1: 50 parts
Amorphous resin 1: 30 parts
Wax 1: 10 parts
Colorant 1: 5 parts
(cyan pigment Pigment Blue 15:3, commercially available from Dainichiseika Color & Chemicals Mfg. Co., Ltd.)
Inorganic filler: 5 parts
(calcium carbonate number-average particle diameter of 0.3 μm fatty acid (stearic acid) treatment)

The above materials were mixed using a Henschel mixer (FM-75 model, commercially available from Nippon Coke & Engineering. Co., Ltd.) at a rotation speed of 25 s-1 for a rotation time of 5 min, and then kneaded in a twin-screw kneading machine (PCM-30 model, commercially available from Ikegai) set at a temperature of 120° C., at a screw rotation speed of 250 rpm, and a discharge temperature of 130° C.

The obtained melt-kneaded product was placed in a stainless steel vat and annealed by holding it at 75° C. for 45 minutes. The obtained resin composition was cooled to room temperature and coarsely pulverized to 1 mm or less using a hammer mill to obtain a coarsely pulverized product. The obtained pulverized product was finely pulverized using a mechanical pulverizer (T-250, commercially available from Freund Turbo Co., Ltd.).

In addition, classification was performed using Faculty F-300 (commercially available from Hosokawa Micron Corporation) to obtain a toner particle 1 having a weight-average particle diameter (D4) of 6.0 μm, an average circularity of 0.965, and a domain number average diameter of 0.20 μm. The operating conditions were a classifying rotor rotation speed of 130 s⁻¹ and a dispersion rotor rotation speed of 120 s⁻¹.

### <Production Example of Toner Particles 2 to 20>

Toner particles 2 to 20 were obtained by performing the production in the same manner as in the production example of the toner particle 1 except that the type and parts of the crystalline resin added, the type and parts of the amorphous resin added, kneading conditions, and annealing conditions were changed as shown in Table 4 and Table 5.

TABLE 4

| | | | | | | | | | | Filler | | | |
|---|---|---|---|---|---|---|---|---|---|---|---|---|---|
| Toner | Crystalline | | Amorphous | | \|Tc − | WAX | | | | | Particle | | |
| particle | resin | | resin | | Tg\| | | Melting | Number | SP | | diameter | Surface | Number |
| No. | No. | Parts | No. | Parts | ° C. | Type | point | of parts | value | Type | μm | treatment | of parts |
| 1 | 1 | 50.0 | 1 | 30.0 | 5 | Wax 1 | 90 | 10 | 17.1 | Calcium | 0.3 | Fatty acid | 5 |
| | | | | | | | | | | carbonate | | treatment | |
| 2 | 1 | 53.0 | 1 | 32.0 | 5 | Wax 1 | 90 | 10 | 17.1 | No | — | — | — |
| 3 | 1 | 53.0 | 1 | 32.0 | 5 | Wax 1 | 90 | 10 | 17.1 | No | — | — | — |
| 4 | 1 | 56.0 | 1 | 34.0 | 5 | Wax 1 | 90 | 5 | 17.1 | No | — | — | — |
| 5 | 1 | 56.0 | 1 | 34.0 | 5 | Wax 1 | 90 | 15 | 17.1 | No | — | — | — |
| 6 | 1 | 53.0 | 1 | 32.0 | 5 | Wax 2 | 77 | 10 | 17.0 | No | — | — | — |
| 7 | 1 | 53.0 | 1 | 32.0 | 5 | Wax 3 | 85 | 10 | 17.1 | No | — | — | — |
| 8 | 1 | 53.0 | 1 | 32.0 | 5 | Wax 4 | 105 | 10 | 17.1 | No | — | — | — |
| 9 | 1 | 53.0 | 1 | 32.0 | 5 | Wax 5 | 115 | 10 | 17.2 | No | — | — | — |
| 10 | 2 | 53.0 | 1 | 32.0 | 6 | Wax 1 | 90 | 10 | 17.1 | No | — | — | — |
| 11 | 3 | 53.0 | 1 | 32.0 | 4 | Wax 1 | 90 | 10 | 17.1 | No | — | — | — |
| 12 | 4 | 35.0 | 1 | 50.0 | 9 | Wax 1 | 90 | 10 | 17.1 | No | — | — | — |
| 13 | 4 | 80.0 | 1 | 5.0 | 9 | Wax 1 | 90 | 10 | 17.1 | No | — | — | — |
| 14 | 4 | 80.0 | — | No | 9 | Wax 1 | 90 | 10 | 17.1 | Calcium | 0.3 | Fatty acid | 5 |
| | | | | | | | | | | carbonate | | treatment | |
| 15 | 6 | 50.0 | 1 | 25.0 | 12 | Wax 1 | 90 | 10 | 17.1 | Calcium | 0.3 | Fatty acid | 10 |
| | | | | | | | | | | carbonate | | treatment | |
| 16 | 7 | 50.0 | 1 | 25.0 | 27 | Wax 1 | 90 | 10 | 17.1 | Calcium | 0.3 | Fatty acid | 10 |
| | | | | | | | | | | carbonate | | treatment | |
| 17 | 1 | 25.0 | 1 | 50.0 | 5 | Wax 1 | 90 | 10 | 17.1 | Calcium | 0.3 | Fatty acid | 5 |
| | | | | | | | | | | carbonate | | treatment | |
| 18 | 5 | 60.0 | 1 | 25.0 | 4 | Wax 1 | 90 | 10 | 17.1 | No | — | — | — |
| 19 | 4 | 80.0 | — | No | — | Wax 1 | 90 | 10 | 17.1 | Calcium | 0.3 | Fatty acid | 5 |
| | | | | | | | | | | carbonate | | treatment | |
| 20 | 4 | 60.0 | 1 | 25.0 | 9 | Wax 6 | 75 | 10 | 17.6 | No | — | — | — |

The unit of the SP value is (J/cm³)^{0.5}.

TABLE 5

| | Kneading conditions | | | | | |
|---|---|---|---|---|---|---|
| Toner | Screw | | Annealing | | | |
| particle | rotation | Kneading | Annealing | Annealing | Annealing | |
| No. | speed | temperature | step | time | temperature | Tw − Ta |
| 1 | 250 rpm | 120° C. | After | 45 min | 75° C. | 15 |
| | | | kneading | | | |
| 2 | 250 rpm | 120° C. | After | 45 min | 75° C. | 15 |
| | | | kneading | | | |
| 3 | 250 rpm | 120° C. | After | 30 min | 85° C. | 5 |
| | | | kneading | | | |
| 4 | 250 rpm | 120° C. | After | 45 min | 75° C. | 15 |
| | | | kneading | | | |
| 5 | 250 rpm | 120° C. | After | 45 min | 75° C. | 15 |
| | | | kneading | | | |
| 6 | 250 rpm | 120° C. | After | 45 min | 75° C. | 2 |
| | | | kneading | | | |
| 7 | 250 rpm | 120° C. | After | 45 min | 75° C. | 10 |
| | | | kneading | | | |
| 8 | 250 rpm | 120° C. | After | 45 min | 75° C. | 30 |
| | | | kneading | | | |
| 9 | 250 rpm | 120° C. | After | 45 min | 75° C. | 40 |
| | | | kneading | | | |
| 10 | 250 rpm | 120° C. | After | 45 min | 75° C. | 15 |
| | | | kneading | | | |
| 11 | 250 rpm | 120° C. | After | 45 min | 75° C. | 15 |
| | | | kneading | | | |
| 12 | 250 rpm | 120° C. | After | 45 min | 75° C. | 15 |
| | | | kneading | | | |
| 13 | 250 rpm | 120° C. | After | 45 min | 75° C. | 15 |
| | | | kneading | | | |
| 14 | 250 rpm | 120° C. | After | 45 min | 75° C. | 15 |
| | | | kneading | | | |
| 15 | 250 rpm | 120° C. | After | 45 min | 75° C. | 15 |
| | | | kneading | | | |
| 16 | 250 rpm | 120° C. | No | — | — | — |
| 17 | 250 rpm | 120° C. | No | — | — | — |
| 18 | 250 rpm | 120° C. | No | — | — | — |
| 19 | 250 rpm | 120° C. | No | — | — | — |
| 20 | 250 rpm | 120° C. | After | 45 min | 72 | 3 |
| | | | kneading | | | |

### <Production Example of Toner 1>

| | |
|---|---|
| Toner particle 1 | 100 parts |

Silica particle 1 (fumed silica with a number average diameter of 30 nm treated with silicone oil), 2.0 parts

The above materials were mixed using a Henschel mixer FM-10C model (commercially available from Mitsui Miike Machinery Co., Ltd.) at a rotation speed of 30 s⁻¹ for a rotation time of 10 min to obtain a toner 1. The viscoelasticity and the rate of change in WAX crystallinity of the obtained toners were measured by the above method and shown in Table 6.

The cross section of the obtained toner was measured by the above method, and as a result, it was confirmed that the matrix contained the crystalline resin, and the domain contained the amorphous resin.

### <Production Example of Toners 2 to 20>

Toners 2 to 20 were obtained by performing the production in the same manner as in the production example of the toner 1 except that the toner particles were changed to toner particles 2 to 20.

For the obtained toners 1 to 20, when the content of the crystalline resin, the content of the first monomer unit in the crystalline resin, and the content of the inorganic filler particle were measured by the above method, it was confirmed that these values matched the parts added when the toners were produced.

### <Production Example of Magnetic Carrier 1>

Magnetite 1 with a number-average particle diameter of 0.30 μm (an intensity of magnetization of 65 Am²/kg under a magnetic field of 1000/4π (kA/m))

Magnetite 2 with a number-average particle diameter of 0.50 μm (an intensity of magnetization of 65 Am²/kg under a magnetic field of 1000/4π (kA/m))

4.0 parts of a silane compound (3-(2-aminoethylaminopropyl)trimethoxysilane) was added to 100 parts of each of the above materials, the mixture was mixed and stirred in a container at a high speed and 100° C. or higher, and respective fine particles were treated.
Phenol: 10 mass %
Formaldehyde solution: 6 mass % (formaldehyde 40 mass %, methanol 10 mass %, water 50 mass %)
Magnetite 1 treated with the silane compound: 58 mass %
Magnetite 2 treated with the silane compound: 26 mass %

100 parts of the above material, 5 parts of a 28 mass % ammonia aqueous solution, and 20 parts of water were put into a flask, the mixture was heated to 85° C. for 30 minutes and held while stirring and mixing, a polymerization reaction was performed for 3 hours, and the produced phenolic resin was cured. Then, the cured phenolic resin was cooled to 30° C., water was additionally added, the supernatant liquid was then removed, and the precipitate was washed with water and then air-dried. Next, the sample was dried under a reduced pressure (5 mmHg or less) at a temperature of 60° C. to obtain a magnetic body dispersed spherical magnetic carrier 1. The volume-based 50% particle diameter (D50) of the magnetic carrier 1 was 34.2 μm.

### <Production Example of Two-Component Developer 1>

8.0 parts of the toner 1 were added to 92.0 parts of the magnetic carrier 1, and mixed using a V-type mixer (V-20, commercially available from Seishin Enterprise Co., Ltd.) to obtain a two-component developer 1.

### <Production Example of Two-Component Developers 2 to 20>

Two-component developers 2 to 20 were obtained using the toners 2 to 20 in the production example of the two-component developer 1.

TABLE 6

| | | | | | | | | Rate of | | | | |
|---|---|---|---|---|---|---|---|---|---|---|---|---|
| | Toner | | | | | | | change in | | | | |
| Toner | particle | T1 | | | | G′(T1) | G′(T1 + 30) | WAX | Tw − | W(C)/ | MD | Domain |
| No. | No. | ° C. | X | Y | Z | (Pa) | (Pa) | crystallinity | Tc | W(W) | structure | composition |
| 1 | 1 | 60.0 | −0.95 | −0.05 | 0.90 | 4.8E+06 | 1.8E+04 | 0.85 | 29 | 2.5 | Yes | Amorphous |
| | | | | | | | | | | | | resin |
| 2 | 2 | 60.0 | −1.05 | −0.10 | 0.95 | 4.6E+06 | 1.2E+04 | 0.85 | 29 | 3.2 | Yes | Amorphous |
| | | | | | | | | | | | | resin |
| 3 | 3 | 60.0 | −1.05 | −0.10 | 0.95 | 6.8E+08 | 1.6E+04 | 0.85 | 29 | 3.2 | Yes | Amorphous |
| | | | | | | | | | | | | resin |
| 4 | 4 | 60.0 | −1.10 | −0.15 | 0.95 | 2.8E+06 | 5.5E+03 | 0.73 | 29 | 6.7 | Yes | Amorphous |
| | | | | | | | | | | | | resin |
| 5 | 5 | 60.0 | −1.00 | −0.05 | 0.95 | 6.0E+06 | 1.3E+04 | 0.86 | 29 | 1.9 | Yes | Amorphous |
| | | | | | | | | | | | | resin |
| 6 | 6 | 58.0 | −0.40 | −0.12 | 0.26 | 4.5E+06 | 3.0E+02 | 0.85 | 16 | 3.2 | Yes | Amorphous |
| | | | | | | | | | | | | resin |
| 7 | 7 | 59.0 | −0.80 | −0.15 | 0.65 | 4.8E+06 | 8.0E+02 | 0.85 | 25 | 3.2 | Yes | Amorphous |
| | | | | | | | | | | | | resin |
| 8 | 8 | 61.0 | −1.20 | −0.10 | 1.10 | 5.0E+06 | 9.0E+03 | 0.85 | 44 | 3.2 | Yes | Amorphous |
| | | | | | | | | | | | | resin |
| 9 | 9 | 61.0 | −1.60 | −0.20 | 1.40 | 5.2E+06 | 4.5E+04 | 0.85 | 54 | 3.2 | Yes | Amorphous |
| | | | | | | | | | | | | resin |
| 10 | 10 | 60.0 | −1.10 | −0.15 | 0.95 | 5.0E+06 | 1.4E+04 | 0.85 | 29 | 3.2 | Yes | Amorphous |
| | | | | | | | | | | | | resin |
| 11 | 11 | 60.0 | −1.10 | −0.15 | 0.95 | 4.8E+06 | 1.6E+04 | 0.85 | 29 | 3.2 | Yes | Amorphous |
| | | | | | | | | | | | | resin |
| 12 | 12 | 63.0 | −1.10 | −0.15 | 0.95 | 5.2E+06 | 4.5E+04 | 0.90 | 25 | 3.5 | Yes | Amorphous |
| | | | | | | | | | | | | resin |
| 13 | 13 | 63.0 | −1.40 | −0.45 | 0.95 | 7.5E+05 | 1.5E+03 | 0.80 | 25 | 8.0 | Yes | Amorphous |
| | | | | | | | | | | | | resin |
| 14 | 14 | 63.0 | −1.70 | −0.10 | 1.60 | 5.2E+05 | 1.0E+04 | 0.80 | 25 | 8.0 | No | No |
| 15 | 15 | 67.0 | −0.40 | −0.08 | 0.32 | 6.0E+05 | 2.0E+03 | 0.68 | 22 | 0.0 | Yes | Amorphous |
| | | | | | | | | | | | | resin |
| 16 | 16 | 83.0 | −0.45 | −0.40 | 0.05 | 1.0E+05 | 2.0E+03 | 0.96 | 7 | 0.0 | Yes | Amorphous |
| | | | | | | | | | | | | resin |
| 17 | 17 | 61.0 | −0.12 | −0.07 | 0.05 | 1.0E+07 | 6.0E+04 | 0.92 | 29 | 1.5 | Yes | Crystalline |
| | | | | | | | | | | | | resin |
| 18 | 18 | 61.0 | −0.18 | −0.10 | 0.08 | 1.0E+05 | 1.0E+04 | 0.60 | 31 | 5.4 | Yes | Amorphous |
| | | | | | | | | | | | | resin |
| 19 | 19 | 61.0 | −0.70 | −0.58 | 0.12 | 8.0E+04 | 2.0E+02 | 0.64 | 25 | 8.0 | Yes | Amorphous |
| | | | | | | | | | | | | resin |
| 20 | 20 | 60.0 | −0.60 | −0.52 | 0.08 | 5.5E+04 | 8.0E+01 | 0.60 | 15 | 6.0 | Yes | Amorphous |
| | | | | | | | | | | | | resin |

In the table, X indicates the value of d(log G′(T1))/dT, and Y indicates the value of d(log G′(T1+3))/dT. Z indicates the value of d(log G′(T1+3))/dT-d(log G′(T1))/dT.

For example, 4.8E+06 indicates 4.8×10⁶.

The rate of change in wax crystallinity indicates the value of ΔH(T)/ΔH(W).

In the MD structure column, “yes” indicates that a matrix domain structure was present when a cross section of the toner was observed under a transmission electron microscope. The domain composition indicates the type of the resin forming the domain in the matrix domain structure.

### Example 1

### [Low-Temperature Fixability]

Evaluation was performed using the two-component developer 1.

A modified digital commercial printing printer (imageRUNNER ADVANCE C5560, commercially available from Canon Inc.) was used as an image forming apparatus, and the two-component developer 1 was placed in a cyan developing device. The modification of the device included changing it such that the fixation temperature, the process speed, the DC voltage VDC of the developer bearing member, the charging voltage VD of the electrostatic latent image bearing member, and the laser power could be freely set. For the image output evaluation, an FFh image (solid image) with a desired image ratio was output, VDC, VD, and laser power were adjusted so that the amount of the toner deposited on the FFh image on the paper reached a desired amount, and the low-temperature fixability was evaluated.

FFh is a hexadecimal value representing 256 gradations, with 00h being the first gradation (white background) of the 256 gradations and with FFh being the 256th gradation (sold area) of the 256 gradations.

Evaluation was performed on the basis of the following evaluation method, and the results are shown in Table 7.
Paper: GFC-081 (81.0 g/m²)
(commercially available from Canon Marketing Japan Inc.)
Amount of toner deposited on paper: 0.70 mg/cm²
(adjusted by the DC voltage VDC of the developer bearing member, the charging voltage VD of the electrostatic latent image bearing member, and the laser power)
Evaluation image: A 2 cm×5 cm image was placed in the center of the A4 paper.
Test environment: low temperature and low humidity environment: temperature 15° C./humidity 10% RH (hereinafter referred to as “L/L”)
Fixation temperature: 140° C.
Process speed: 400 mm/sec

The evaluation images were output, and the low-temperature fixability was evaluated. The value of the rate of decrease in image density was used as an evaluation index for low-temperature fixability.

The rate of decrease in image density was measured using an X-Rite color reflection densitometer (500 series: commercially available from X-Rite Inc.), and first, the image density of the center was measured. Next, a load of 4.9 kPa (50 g/cm²) was applied to the part where the image density was measured, the fixed image was subjected to friction (five times back and forth) with silbon paper, and the image density was measured again. Then, the rate of decrease in image density before and after friction was calculated using the following formula. The obtained a rate of decrease in image density was evaluated according to the following evaluation criteria.

Rate of decrease in image density=(image density before friction-image density after friction)/(image density before friction)×100

### (Evaluation Criteria)

AA: The rate of decrease in image density was less than 1.0%
A: The rate of decrease in image density was 1.0% or more and less than 3.0%
B: The rate of decrease in image density was 3.0% or more and less than 5.0%
C: The rate of decrease in image density was 5.0% or more and less than 8.0%
D: The rate of decrease in image density was 8.0% or more

### [Scratch Resistance]

Paper: Color Copy Coated Silk (250 g/m²) (commercially available from Mondi)
Amount of toner deposited on paper: 0.70 mg/cm²
(adjusted by the DC voltage VDC of the developer bearing member, the charging voltage VD of the electrostatic latent image bearing member, and the laser power)
Evaluation image: A 2 cm×15 cm image was placed in the center of the A4 paper.
Test environment: under a normal temperature and normal humidity environment (a temperature of 23° C., a relative humidity of 50% (hereinafter referred to as N/N))
Fixation temperature: 160° C.
Process speed: 400 mm/s

The evaluation images were output, and the scratch resistance was evaluated. The paper used for evaluation was a coated paper with relatively high smoothness. The scratch resistance was evaluated according to scratches produced on the image by placing a weight of 200 g and scratching it with a needle with a diameter of 0.75 mm at a speed of 60 mm/min and a length of 30 mm using Surface Property Tester HEIDONTYPE14FW (commercially available from Shinto Scientific Co., Ltd.).

Here, the proportion of the area where the toner peeled off was determined by binarizing the area where toner peeling occurred with respect to the scratched area by image processing. The results are shown in Table 7.

### (Evaluation Criteria)

A: The proportion of the area where the toner peeled off due to image scratches was 0% or more and less than 1.0%
B: The proportion of the area where the toner peeled off due to image scratches was 1.0% or more and less than 4.0%
C: The proportion of the area where the toner peeled off due to image scratches was 4.0% or more and less than 7.0%
D: The proportion of the area where the toner peeled off due to image scratches was 7.0% or more

### [Glossiness]

Paper: GFC-081 (81.0 g/m²)
(commercially available from Canon Marketing Japan Inc.)
Amount of toner deposited on paper: 0.35 mg/cm²
(adjusted by the DC voltage VDC of the developer bearing member, the charging voltage VD of the electrostatic latent image bearing member, and the laser power)
Evaluation image: A 2 cm×15 cm image was placed in the center of the A4 paper.
Test environment: under a normal temperature and normal humidity environment (a temperature of 23° C., a relative humidity of 50% (hereinafter referred to as N/N))
Fixation temperature: 160° C.
Process speed: 400 mm/sec

The evaluation images were output, and the image glossiness was evaluated. The image glossiness was evaluated by measuring the average value of three arbitrary points on each image under a condition of an angle of incidence of 60° of light using PG-3D (commercially available from Nippon Denshoku Industries Co., Ltd.), and the measured value was used as the gross value. The results are shown in Table 7.

### (Evaluation Criteria)

A: The gross value was 30 or more.
B: The gross value was 20 or more and less than 30.
C: The gross value was 10 or more and less than 20.
D: The gross value was less than 10.

### [Image Density Non-Uniformity (Mottle) on Rough Paper]

Paper: Canon Red Label Presentation
(basis weight: 80 g/m²)
Amount of toner deposited on paper: 0.40 mg/cm²
(adjusted by the DC voltage VDC of the developer bearing member, the charging voltage VD of the electrostatic latent image bearing member, and the laser power)
Evaluation image: FFh image with a printing ratio of 100%
Test environment: under a normal temperature and normal humidity environment (a temperature of 23° C., a relative humidity of 50% (hereinafter referred to as N/N))
Fixation temperature: 180° C.
Process speed: 400 mm/sec

The evaluation images were output, and the image density non-uniformity (mottle) on rough paper was evaluated. Paper with significant unevenness was used, the fixation temperature was set higher than in the evaluation of the low-temperature fixability, scratch resistance, and glossiness, and evaluation was performed under conditions in which image density non-uniformity (mottle) was more likely to occur.

The mottle in the obtained image was visually confirmed and determined according to the following index. Mottle is a type of image defect caused by poor fixing, in which the melt viscosity of the toner is too low, and the influence of the unevenness of media appears in the image, resulting in a rough image. The results are shown in Table 7.

### (Evaluation Criteria)

A: No mottle was observed in any of 100 sheets.
B: Mottle was observed in 1 to 3 out of 100 sheets.
C: Mottle was observed in 4 to 9 out of 100 sheets.
D: Mottle was observed in 10 or more out of 100 sheets.

### Examples 2 to 15 and Comparative Examples 1 to 5

The low-temperature fixability, scratch resistance, glossiness, and image density non-uniformity on rough paper were evaluated in the same manner as in Example 1 except that the two-component developers 2 to 20 were used in place of the two-component developer 1. The evaluation results are shown in Table 7.

TABLE 7

| | | | Toner property evaluation | | | |
|---|---|---|---|---|---|---|
| | | | Low- | | | Image density |
| | Toner | Two-component | temperature | Scratch | | non-uniformity |
| | No. | developer No. | fixability | resistance | Glossiness | on rough paper |
| Example 1 | 1 | 1 | A | A | A | A |
| Example 2 | 2 | 2 | A | A | A | A |
| Example 3 | 3 | 3 | A | A | A | A |
| Example 4 | 4 | 4 | A | A | A | A |
| Example 5 | 5 | 5 | A | A | A | A |
| Example 6 | 6 | 6 | A | C | A | C |
| Example 7 | 7 | 7 | A | A | A | B |
| Example 8 | 8 | 8 | A | A | A | A |
| Example 9 | 9 | 9 | A | B | C | A |
| Example 10 | 10 | 10 | A | A | A | A |
| Example 11 | 11 | 11 | A | A | A | A |
| Example 12 | 12 | 12 | C | A | C | B |
| Example 13 | 13 | 13 | AA | C | B | B |
| Example 14 | 14 | 14 | AA | C | B | B |
| Example 15 | 15 | 15 | A | C | B | A |
| Comparative | 16 | 16 | D | D | B | A |
| Example 1 | | | | | | |
| Comparative | 17 | 17 | D | D | D | A |
| Example 2 | | | | | | |
| Comparative | 18 | 18 | C | D | B | A |
| Example 3 | | | | | | |
| Comparative | 19 | 19 | AA | D | B | C |
| Example 4 | | | | | | |
| Comparative | 20 | 20 | C | D | B | D |
| Example 5 | | | | | | |

According to at least one aspect of the present disclosure, it is possible to provide a toner that exhibits excellent low-temperature fixability and excellent resistance to scratches on an image printed on smooth media such as coated paper, and can achieve image glossiness and reduce image density non-uniformity on fixing media with significant unevenness. In addition, according to at least one aspect of the present disclosure, it is possible to provide a method of producing the toner.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A toner comprising a toner particle comprising a binder resin and a wax,
wherein the binder resin comprises a crystalline resin,
the content of the crystalline resin based on the mass of the toner particle is 30.0 to 95.0 mass %,
in viscoelastic measurement of the toner, when a storage elastic modulus of the toner at a temperature T (° C.) is G′(T),
in a graph in which a horizontal axis represents the temperature T, and a vertical axis represents a value d(log G′(T))/dT obtained by differentiating Log G′(T) with respect to the temperature T,
the local minimum value is observed in a range of 50.0 to 70.0° C., and
when a temperature at which the local minimum value is reached is defined as a temperature T1 (° C.),
$$d ( log {G}^{′} ( T 1 ) ) / dT is - 2. to 0.2 , d ( log {G}^{′} ( T 1 + 3 ) ) / dT \leq 0 , d ( log {G}^{′} ( T 1 + 3 ) ) / dT - d ( log {G}^{′} ( T 1 ) ) / dT is 0.15 to 1.9 , {G}^{′} ( T 1 ) is 5. \times 1 {0}^{5} to 2. \times 1 {0}^{7} Pa , and \\ {G}^{′} ( T 1 + 30 ) is 1. \times 1 {0}^{2} to 5. \times 1 {0}^{4} Pa .$$

2. The toner according to claim 1,
wherein, when a melting point of the wax is Tw (° C.), and a melting point of the crystalline resin is Tc (° C.), Tw and Tc satisfy the following relationship:
$$20 \leq Tw - Tc \leq 50 .$$

3. The toner according to claim 1,
wherein, when a total endothermic amount J/g per 1 g of the wax, which is derived from the wax, in endothermic amount measurement of the toner, is ΔH(T), and a total endothermic amount J/g per 1 g of the wax in endothermic amount measurement of the wax is ΔH(W),
$$Δ H ( T ) and Δ H ( W ) satisfy \\ 0.7 \leq Δ H ( T ) / Δ H ( W ) \leq 0.90 .$$

4. The toner according to claim 1,
wherein the crystalline resin comprises a monomer unit represented by the following formula 1 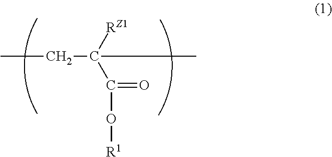
in the formula (1), R^{Z1} represents a hydrogen atom or a methyl group, and R¹ represents an alkyl group having 18 to 36 carbon atoms.

5. The toner according to claim 4,
wherein, when a content of the monomer unit represented by the formula (1) based on the mass of the toner particle is W(C), and the content of the wax based on the mass of the toner particle is W(W),
W(C) and W(W) satisfy the following relationship
$$1. 8 \leq W ( C ) / W ( W ) \leq 7.0 .$$

6. The toner according to claim 1,
wherein the wax comprises a hydrocarbon-based wax.

7. The toner according to claim 1,
wherein the binder resin comprises an amorphous resin.

8. The toner according to claim 7,
wherein, when a cross section of the toner is observed under a transmission electron microscope, a matrix domain structure composed of a matrix comprising the crystalline resin and a domain comprising the amorphous resin is present.

9. A method of producing the toner according to claim 1, the method comprising:
a melt-kneading step in which a mixture comprising the crystalline resin and the wax is melt-kneaded; and
an annealing step in which the melt-kneaded product obtained in the melt-kneading step is held at a temperature at least 5° C. higher than the melting point of the crystalline resin.
